(19) United States
(12) Patent Application Publication
(10) Pub. No.: US 2005/0220042 A1
(43) Pub. Date: Oct. 6, 2005

(54) Method and apparatus for transmitting scheduling grant information using a transport format combination indicator in Node B controlled scheduling of an uplink packet transmission

(75) Inventors: Jin-Weon Chang, Suwon-si (KR); Seong-III Park, Seongnam-si (KR); Ju-Ho Lee, Suwon-si (KR); Kwang-Yung Jeong, Yongin-si (KR); Young-Bin Chang, Seoul (KR); Hye-Young Lee, Seoul (KR); Jin-Seok Lee, Seongnam-si (KR); Song-Hun Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/065,819

(22) Filed: Feb. 25, 2005

(30) Foreign Application Priority Data
Feb. 26, 2004 (KR) 13140/2004
Mar. 4, 2004 (KR) 14593/2004

(51) Int. Cl. H04L 12/28; H04L 12/56

(52) U.S. Cl. 370/278; 370/329; 370/395.4

(57) ABSTRACT

A method and apparatus for transmitting scheduling grant information by a TFCI in Node B controlled scheduling of uplink packet transmission. In one embodiment, a scheduling command resulting from Node B controlled scheduling is mapped onto a TFCI and transmitted on the downlink. In another embodiment, an ACK/NACK signal determining retransmission of uplink packet data is mapped onto a TFCI and transmitted on the downlink.

### PRIORITY

This application claims priority under 35 U.S.C. § 119 to an application entitled “Method and Apparatus for Transmitting Scheduling Grant Information Using Transport Format Combination Indicator in Node B Controlled Scheduling of Uplink Packet Transmission” filed in the Korean Intellectual Property Office on Feb. 26, 2004 and assigned Ser. No. 2004-13140, and to an application entitled “Method and Apparatus for Transmitting Scheduling Grant Information Using Transport Format Combination Indicator in Node B Controlled Scheduling of Uplink Packet Transmission” filed in the Korean Intellectual Property Office on Mar. 4, 2004 and assigned Ser. No. 2004-14593, the contents of both of which are incorporated herein by reference.

### BACKGROUND OF THE INVENTION

1. Field of the Invention

The present invention relates generally to a cellular CDMA (Code Division Multiple Access) communication system, and in particular, to a method and apparatus for using an EUDCH (Enhanced Uplink Data Channel).

2. Description of the Related Art

A 3^{rd} generation mobile communication system, i.e., a UMTS (Universal Mobile Telecommunication Service), is based on GSM (Global System for Mobile communication) and GPRS (General Packet Radio Services). The system provides a uniform service that transmits packetized text, digital voice and video, and multimedia data at a rate of 2 Mbps or higher to mobile subscribers or computer users.

With the introduction of the concept of virtual access, UMTS enables access to any end point in a network at all times. The virtual access refers to packet-switched access using a packet protocol like IP (Internet Protocol).

More specifically, the UMTS system uses the EUDCH to improve packet transmission performance on the uplink directed from a UE (User Equipment) to a Node B. To provide stable high-speed data transmission, the EUDCH supports AMC (Adaptive Modulation and Coding), HARQ (Hybrid Automatic Retransmission Request), and Node B controlled scheduling.

The EUDCH was proposed to improve packet transmission performance in uplink communication with a new technology introduced in an asynchronous CDMA communication system. Without the EUDCH, an uplink data rate is not controlled by the Node B but by the UE within an allowed maximum data rate set by the system. However, for the EUDCH, the Node B determines if uplink data is to be transmitted, and a possible data rate limit. The Node B then sends the results to the UE as scheduling information and the UE determines the data rate of the EUDCH based on the scheduling information.

No synchronization is kept. That is, no orthogonality is maintained between uplink signals transmitted by different UEs. This results in interference between the uplink signals. As the Node B receives more uplink signals, the uplink signal from a specific UE experiences more interference and thus its reception performance is degraded.

However, this problem can be solved by increasing the transmit power of the uplink signal. Yet, the increased uplink transmit power in turn interferes with another uplink signal, thereby degrading reception performance.

Due to the above-described phenomenon, the Node B receives a limited amount of an uplink signal of which the reception performance is ensured. The limited uplink signal reception can be addressed in terms of ROT (Rise Over Thermal) defined as Io/No. Io is the power spectral density of the whole wide reception band at the Node B, that is, the amount of the total uplink signal received at the Node B, and No is the power spectral density of thermal noise at the Node B. Therefore, a permitted maximum ROT is equivalent to radio resources available to the uplink in the Node B.

As an uplink data rate increases in the UE, the reception power of the Node B increases as much as an increase in the transmitted uplink signal. Thus, the UE occupies more of the ROT. However, if the UE transmits data at a lower data rate, the uplink signal weakens, occupying less of the ROT. That is, a higher uplink data rate occupies more of the ROT, i.e., more uplink radio resources. The Node B schedules EUDCH packet data transmission, taking into account the relationship between uplink data rate and radio resources and requested uplink data rates.

FIG. 1 illustrates uplink packet transmission on the EUDCH in a conventional wireless communication system. Referring to FIG. 1, reference numeral 10 denotes a Node B 10 supporting the EUDCH, and reference numerals 21 to 24 denote UEs using the EUDCH. As illustrated, the UEs 21 to 24 transmit data to the Node B 10 on EUDCHs 11 to 14, respectively.

The Node B 10 notifies the individual UEs 21 to 24 whether EUDCH transmission is available to them, or performs scheduling for controlling EUDCH data rates, based on the data buffer statuses, requested data rates, or channel statuses of the UEs 21 to 24. The scheduling allocates a low data rate to a remote UE and a high data rate to a nearby UE, and maintains an ROT measured at the Node B below a target ROT.

The distances from the UEs 21 to 24 to the Node B 10 are different: the UE 21 is nearest to the Node B 10; and the UE 24 is farthest from the Node B 10. The EUDCH 11 from the UE 21 is weakest, whereas the EUDCH 14 from the UE 24 is strongest. In this state, the Node B 10 performs scheduling such that the transmit power level is inversely proportional to the data rate, thereby reducing inter-cell interference and achieving the highest performance. More specifically, in the scheduling, the Node B 10 allocates the highest data rate to the UE 21 which is nearest and thus has the smallest uplink transmit power, and the lowest data rate to the UE 24, which is farthest and thus has the highest uplink transmit power.

As illustrated in FIGS. 2A and 2B, a total ROT received in the Node B is the sum of inter-cell interference 106 (114), voice traffic 104 (112), and EUDCH packet traffic 102 (110).

FIG. 2A illustrates the change of the total ROT without Node B controlled scheduling. With no scheduling of EUDCH packet traffic, if UEs transmit packets at high data rates at the same time, a received ROT exceeds a target ROT, making it impossible to ensure uplink reception performance.

On the other hand, in FIG. 2B, Node B controlled scheduling avoids the simultaneous high-rate data packet transmissions from UEs, while maintaining the received ROT around or at the target ROT and thus ensuring the reception performance. If a high data rate has been allowed for a particular UE, the Node B controlled scheduling does not allocate a high data rate to another UE so that the received ROT is kept below the target ROT.

FIG. 3 is a diagram illustrating a basic procedure for uplink packet transmission in the conventional wireless communication system. In the illustrated case, an EUDCH service is provided between a UE 210 and a Node B 200.

Referring to FIG. 3, the EUDCH is established between the Node B 200 and the UE 210 by transmission/reception of messages on dedicated transport channels in step 202. In step 204, the UE 210 transmits to the Node B 200 information about data buffer status or data rate, and information indicating uplink channel status. The node B 200 determines a permitted maximum data rate for the uplink packet channel of the UE 210 based on the received information in step 206. The UE 210 then determines the data rate of the next packet within the maximum data rate and transmits the packet data at the determined rate to the Node B 200 in step 208.

The Node B 200 transmits to the UE 210 an ACK (Acknowledgement) signal after a successful packet reception or an NACK (Negative Acknowledgement) signal after a failed packet reception. In the former case, the UE 210 transmits the next packet data and in the latter case, it retransmits the transmitted packet data.

FIG. 4 is a block diagram of a conventional transmitter in a UE for transmitting uplink physical channels to support the EUDCH service. The transmitter is configured to transmit a DPDCH (Dedicated Physical Data Channel), a DPCCH (Dedicated Physical Control Channel), an HS-DPCCH (High Speed Dedicated Physical Control Channel) for HSDPA (High Speed Downlink Packet Service), and the EUDCH.

The EUDCH includes an EU-DPCCH (DPCCH for EUDCH) for delivering EUDCH control information, and an EU-DPDCH (DPDCH for EUDCH) for delivering packet data. Packet data carried in the EU-DPDCH is called EUDCH data or EUDCH packet data.

The EU-DPCCH delivers scheduling information such as buffer status and information required for the Node B to estimate the uplink channel status (uplink transmit power or uplink transmit power margin, hereinafter, referred to as channel status information (CSI)). The EU-DPCCH also transmits an E-TFRI (Transport Format and Resource Indicator) indicating TFs of EUDCH packet data. The TFRI is confined to the EUDCH. Compared to the TFCI (Transport Format Combination Indicator) indicating the TF of a transport channel on a TB (Transport Block) basis, the TFRI is designed for efficient EUDCH transmission with no limits in data unit.

As implied from its name, the EU-DPDCH is a dedicated physical data channel for the EUDCH service. The EU-DPDCH delivers packet data at a data rate determined according to scheduling information received from the Node B. Unlike the DPDCH, the EU-DPDCH supports a higher-order modulation scheme like QPSK (Quadrature Phase Shift Keying) and 8PSK (8-ary Phase Shift Keying), as well as BPSK (Binary Phase Shift Keying), such that it can increase the data rate without increasing the number of spreading codes concurrently transmitted.

Referring to FIG. 4, an EUDCH transmission controller 346 receives buffer status information needed for Node B controlled scheduling from an EUDCH data buffer 344, measures a CSI, determines E-TFRI of EUDCH packet data, and generates EU-DPCCH information including the buffer status information, CSI, and E-TFRI. The EUDCH transmission controller 346 identifies the TF of the EUDCH packet data as indicated by the E-TFCI such that the EUDCH packet data is transmitted at or below a permitted maximum data rate set in scheduling assignment information 348 received from the Node B.

An EUDCH packet transmitter 342 retrieves as much data as set in accordance with the TF of the EUDCH packet data from the EUDCH data buffer 344 and outputs EU-DPDCH data, which has been channel-encoded at a coding rate and modulated in a modulation scheme. The coding rate and the modulation scheme are determined by the E-TFRI.

DPDCH data and the EU-DPCCH information are spread with OVSF (Orthogonal Variable Spreading Factor) codes C_{d} and C_{c,eu}, respectively, at a chip rate in multipliers 302 and 308, multiplied by channel gains β_{d} and β_{C,eu}, respectively, in multipliers 304 and 310, added in a summer 306, and allocated to an I (In-phase) channel.

Because the EU-DPDCH is a real-number value in BPSK, it is allocated to the I channel. However, the EU-DPDCH is transmitted in complex symbols in QPSK or 8PSK, and thus is allocated to both I and Q (Quadrature-phase) channels.

In FIG. 4, the EU-DPDCH delivers complex symbols. More specifically, a modulation mapper 319 maps the EU-DPDCH data to QPSK or 8PSK complex symbols. The complex symbols are spread with an OVSF code C_{d,eu} at a chip rate in a multiplier 312 and multiplied by a channel gain β_{d,eu} in a multiplier 314.

DPCCH information and HS-DPCCH information are spread with OVSF codes Cc and CHS, respectively, at a chip rate in multipliers 326 and 332, multiplied by channel gains β_{c} and β_{HS}, respectively, in multipliers 328 and 334, added in a summer 336, phase-shifted in a phase shifter 330, and allocated to the Q channel.

A summer 316 generates a complex symbol sequence by summing the real-number value of the summer 306, the complex value of the multiplier 314, and the imaginary-number value of the summer 330. The complex symbol sequence is scrambled with a scrambling code S_{dpch,n} in a scrambler 318, pulse-shaped in a pulse shaping filter 320, modulated to an RF (Radio Frequency) signal in an RF module 322, and then transmitted to the Node B via an antenna 324.

In the above-described conventional technology, excessive signaling overhead is produced when transmitting downlink signals such as scheduling commands and ACK/NACK signals used for the Node B to control uplink packet transmission. Accordingly, a need exists for a technique that efficiently transmits the scheduling commands and the ACK/NAC signals, while minimizing modifications to the physical layer architecture of the Node B.

### SUMMARY OF THE INVENTION

The present invention has been designed to substantially solve at least the above problems and/or disadvantages and to provide at least the advantages below. Accordingly, an object of the present invention is to provide a method and apparatus for efficiently reducing signaling overhead caused by downlink signal transmission in a communication system in which a Node B controls uplink packet transmission.

Another object of the present invention is to provide a method and apparatus for notifying UEs of downlink signal information, thereby minimizing modification to the physical layer channels of a Node B.

A further object of the present invention is to provide a method and apparatus for transmitting and receiving scheduling assignment information required for scheduling of uplink packet transmission.

Still another object of the present invention is to provide a method and apparatus for transmitting and receiving an ACK/NACK signal indicating whether packet data is to be retransmitted or not.

The above objects are achieved by providing a method and apparatus for transmitting scheduling grant information by a TFCI in Node B controlled scheduling of an uplink packet transmission.

According to one aspect of the present invention, in a method of controlling uplink packet data transmission in a mobile communication system, TFCIs are acquired. The TFCIs represent combinations of the TFs of transport channels used for downlink packet data and the TFs of a virtual transport channel used for controlling uplink packet data transmission. A downlink signal destined for a UE is determined, for controlling the uplink packet data transmission. A TCI corresponding to the downlink signal is selected among the TFCIs and transmitted to the UE.

According to another aspect of the present invention, in a method of controlling uplink packet data transmission in a mobile communication system, a TFCI is received from a Node B, which indicates one of combinations of the TFs of transport channels used for downlink packet data and the TFs of a virtual transport channel used for controlling uplink packet data transmission. A downlink signal for controlling the uplink packet data transmission is acquired according to the received TFCI. The uplink packet data transmission is controlled according to the downlink signal.

According to a further aspect of the present invention, in an apparatus for controlling uplink packet data transmission in a Node B in a mobile communication system, a controller determines a downlink signal destined for a UE, for controlling the uplink packet data transmission. A TFCI selector selects a TFCI corresponding to the downlink signal among TFCIs representing combinations of the TFs of transport channels used for downlink packet data and the TFs of a virtual transport channel used for controlling uplink packet data transmission. A transmitter transmits the selected TFCI to the UE.

According to still another aspect of the present invention, in an apparatus for controlling uplink packet data transmission in a UE in a mobile communication system, a TFCI receiver receives from a Node B a TFCI indicating one of combinations of the TFs of transport channels used for downlink packet data and the TFs of a virtual transport channel used for controlling uplink packet data transmission. An analyzer acquires a downlink signal for controlling the uplink packet data transmission according to the received TFCI, and a packet data transmitter controls the uplink packet data transmission according to the downlink signal.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates uplink packet transmission in a conventional wireless communication system;

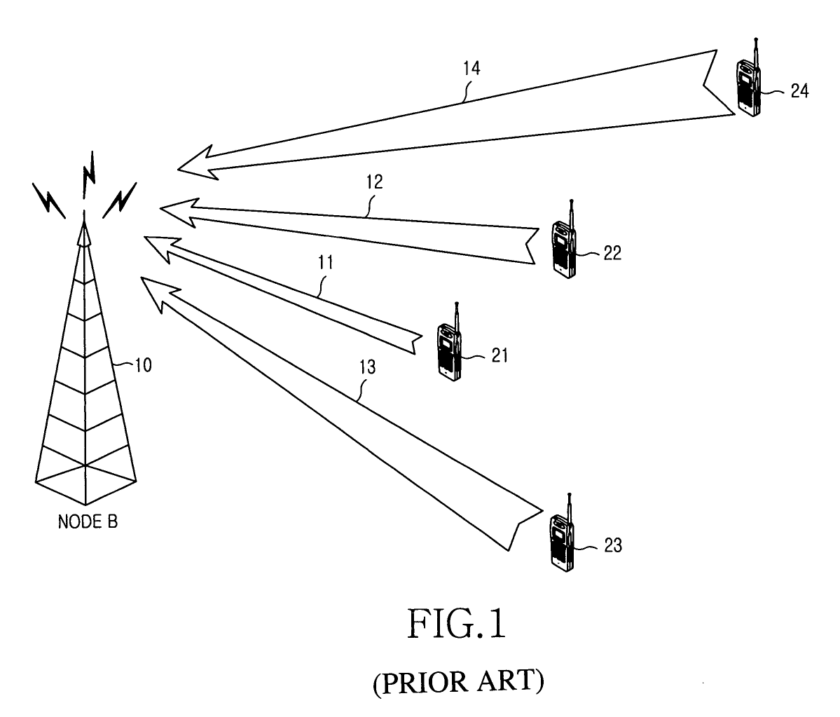

FIGS. 2A and 2B are graphs illustrating changes in Node B received ROT depending on conventional Node B controlled scheduling;

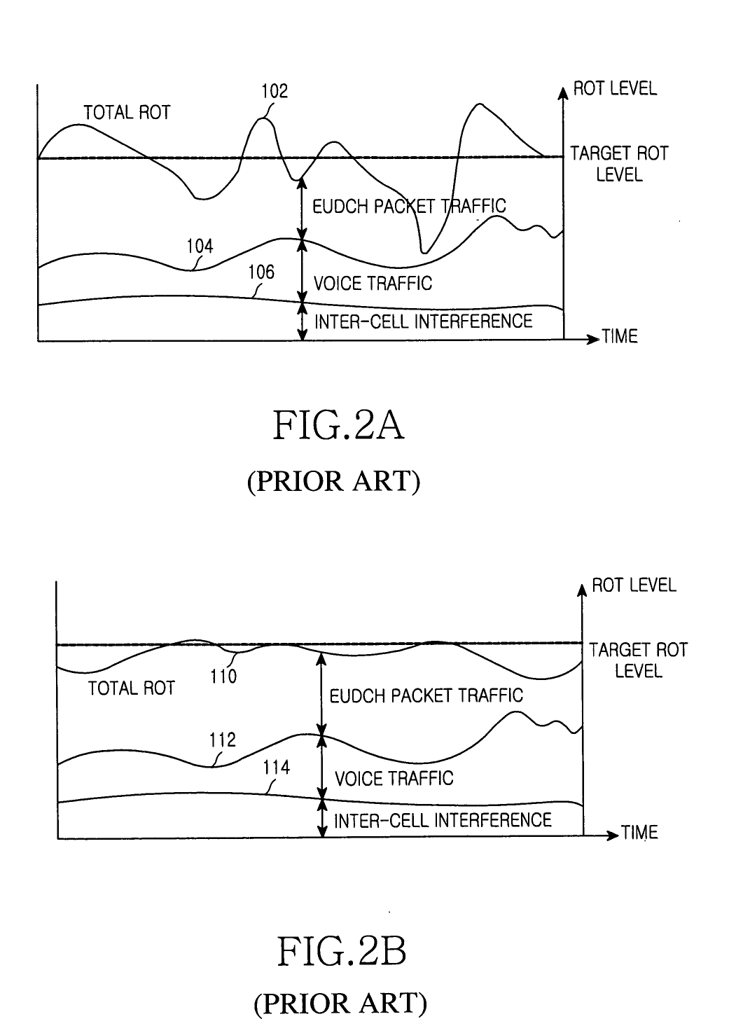

FIG. 3 is a diagram illustrating a basic procedure for uplink packet transmission in the conventional wireless communication system;

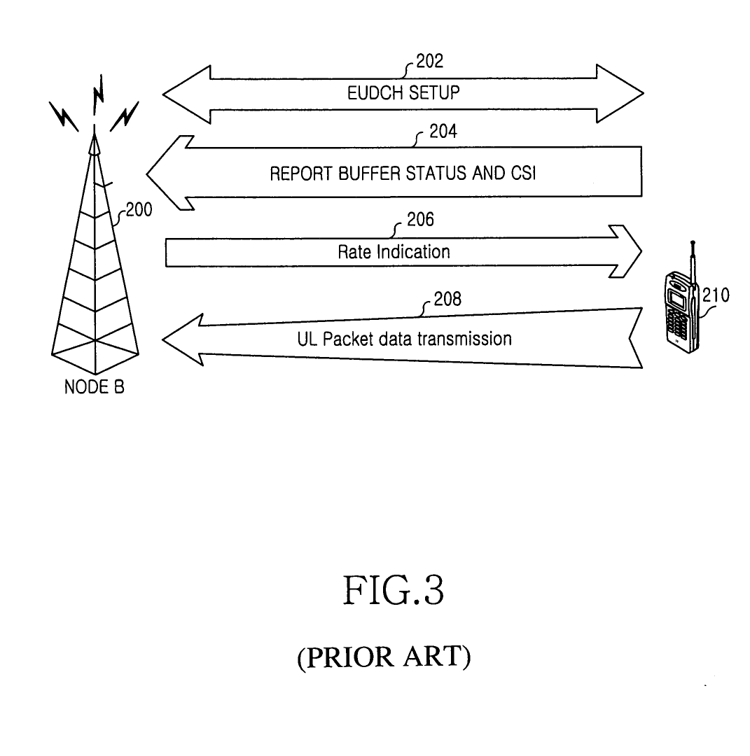

FIG. 4 is a block diagram of a transmitter for transmitting uplink physical channels for supporting a conventional EUDCH service in a UE;

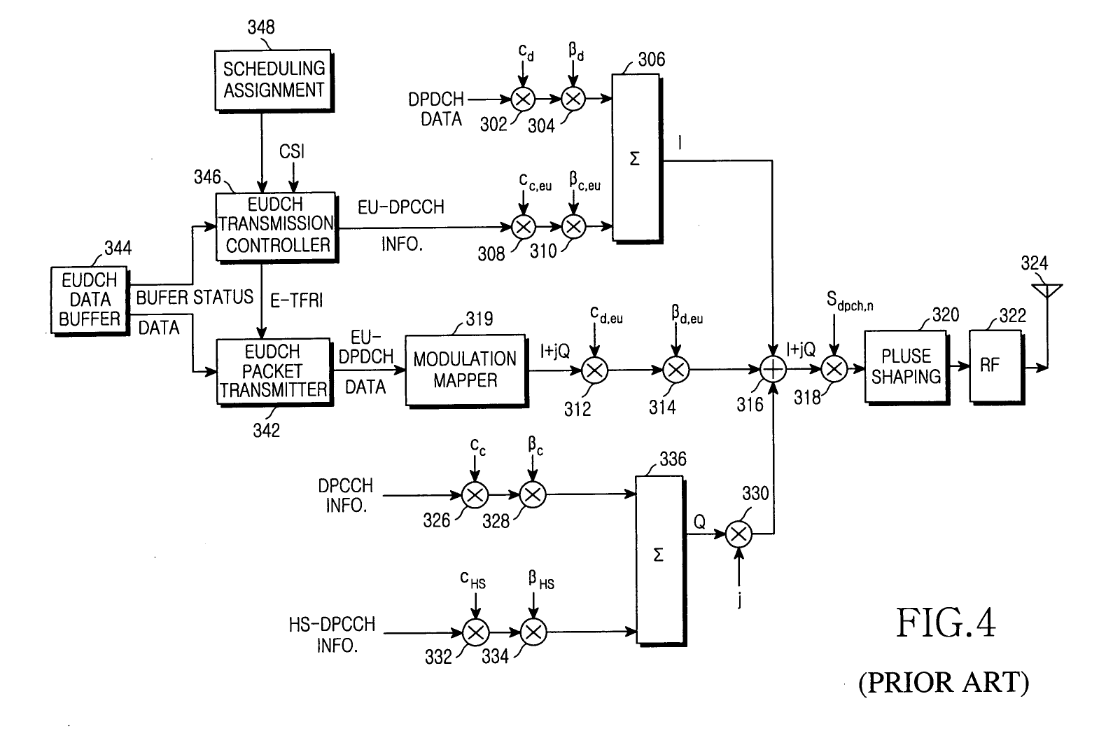

FIG. 5 illustrates a format of an EU-SCHCCH (Scheduling Control Channel for EUDCH) for transmitting EUDCH scheduling commands on a downlink;

FIG. 6 is a block diagram of a transmitter for transmitting EUDCH scheduling commands in a Node B;

FIG. 7 illustrates a signaling procedure for transmitting scheduling information from a UE to a Node B according to a preferred embodiment of the present invention;

FIG. 8 illustrates a format of scheduling information that a UE transmits for EUDCH scheduling of a Node B;

FIG. 9 illustrates formation of TFCIs using TFs of transport channels;

FIG. 10 illustrates transmission of TFCIs derived as illustrated in FIG. 9 on a physical channel;

FIG. 11 illustrates base sequences for channel-encoding of a TFCI;

FIG. 12 illustrates formation of TFCI information involving a virtual transport channel for delivering a scheduling command according to a preferred embodiment of the present invention;

FIG. 13 is a diagram illustrating a signal flow for transmitting an EUDCH scheduling command by a TFCI according to a preferred embodiment of the present invention;

FIG. 14 is a block diagram of a receiver in the Node B, for receiving scheduling information on an EU-DPCCH from the UE according to a preferred embodiment of the present invention;

FIG. 15 is a block diagram of a transmitter in the Node B, for transmitting TFCI information superimposed with an EUDCH scheduling command according to a preferred embodiment of the present invention;

FIG. 16 is a flowchart illustrating an operation for transmitting scheduling grant information by a TFCI in the Node B according to a preferred embodiment of the present invention;

FIG. 17 is a block diagram of a receiver in the UE, for receiving a TFCI on the downlink according to a preferred embodiment of the present invention;

FIG. 18 is a block diagram of a transmitter in the UE, for transmitting EUDCH data blocks on the uplink based on scheduling grant information acquired from a TFCI according to a preferred embodiment of the present invention;

FIG. 19 is a flowchart illustrating an operation for transmitting EUDCH data blocks based on the scheduling grant information acquired from the TFCI in the physical layer of the UE according to a preferred embodiment of the present invention;

FIG. 20 illustrates formation of TFCIs by which the Node B transmits scheduling grant information to the UE according to a preferred embodiment of the present invention;

FIG. 21 illustrates combining of the TFCI of the virtual transport channel used for EUDCH scheduling with that of other transport channels according to a preferred embodiment of the present invention;

FIG. 22 conceptually illustrates packet transmission by HARQ from a UE to a Node B;

FIG. 23 illustrates ACK/NACK transmission on an ACK/NACK channel;

FIG. 24 illustrates ACK/NACK transmission on a dedicated physical channel;

FIG. 25 illustrates formation of TFCI information involving a virtual transport channel according to a preferred embodiment of the present invention;

FIG. 26 is a diagram illustrating a signal flow for transmitting an ACK/NACK signal by a TFCI according to a preferred embodiment of the present invention;

FIG. 27 is a block diagram of a receiver in the Node B, for generating an ACK/NACK signal according to EUDCH data blocks received on the uplink according to a preferred embodiment of the present invention;

FIG. 28 is a block diagram of a transmitter in the Node B, for transmitting TFCI information superimposed with an ACK/NACK on the downlink according to a preferred embodiment of the present invention;

FIG. 29 is a flowchart illustrating an operation for transmitting an ACK/NACK signal by a TFCI in the Node B according to a preferred embodiment of the present invention;

FIG. 30 is a block diagram of a receiver in the UE, for receiving the ACK/NACK signal by the TFCI on the downlink according to a preferred embodiment of the present invention;

FIG. 31 is a block diagram of a transmitter in the UE, for receiving the ACK/NACK signal using the TFCI and transmitting EUDCH data blocks on the uplink according to a preferred embodiment of the present invention; and

FIG. 32 is a flowchart illustrating an operation for acquiring an ACK/NACK signal and transmitting EUDCH data blocks in the physical layer of the UE according to a preferred embodiment of the present invention.

### DETAILED DESCRIPTION OF THE PREFERRED EMBODIMENTS

Preferred embodiments of the present invention will be described in detail herein below with reference to the accompanying drawings. In the following description, well-known functions or constructions are not described in detail because they would obscure the invention in unnecessary detail.

In accordance with the present invention, a virtual transport channel is used to efficiently deliver a downlink signal for controlling an EUDCH. For EUDCH control, a TFCI is set for the virtual transport channel. The virtual transport channel is a channel that is not used for actual transmission. The TFCI of the virtual transport channel is a downlink signal for EUDCH control. Herein below, transmission of a scheduling command by the downlink signal for EUDCH control and transmission of an ACK/NACK by the downlink signal for EUDCH control will be described separately.

Transmission of Scheduling Command

However, before describing transmission of a scheduling command using a TFCI according to preferred embodiments of the present invention, a conventional scheduling command transmission using an additional channel will be described below.

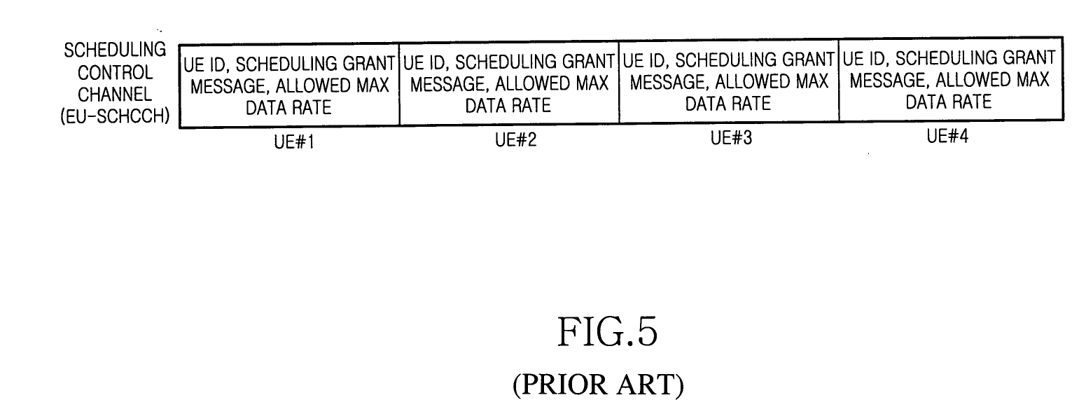

FIG. 5 illustrates the format of an EU-SCHCCH for transmitting EUDCH scheduling commands on a downlink. Referring to FIG. 5, the EU-SCHCCH delivers scheduling commands to a plurality of UEs using one OVSF code, each scheduling command including a scheduling grant message and a maximum data rate for a UE. The scheduling commands each include a UE ID (Identifier) identifying a UE.

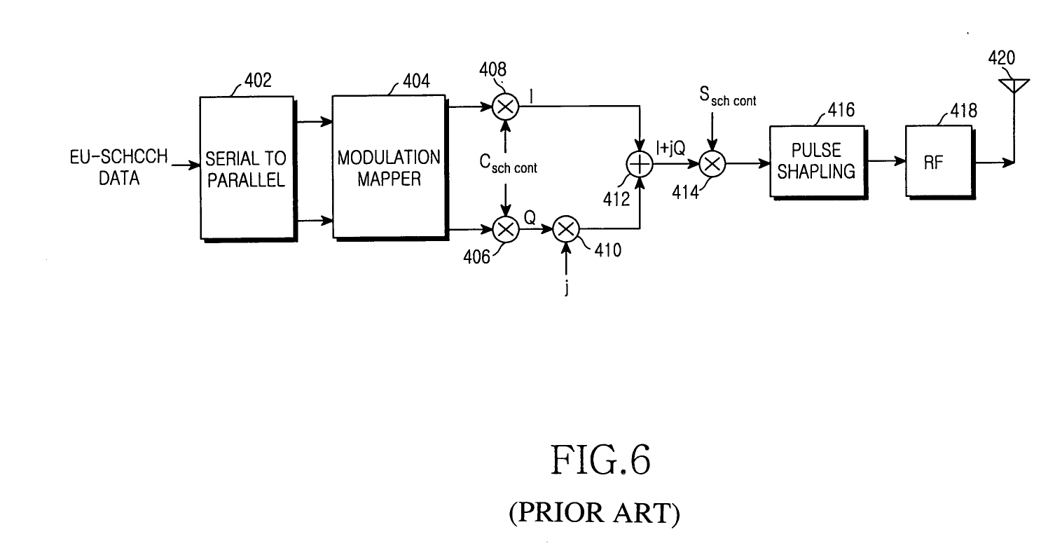

FIG. 6 is a block diagram of a transmitter for transmitting EUDCH scheduling commands in a Node B. Referring to FIG. 6, EU-SCHCCH data containing scheduling commands is converted to two data streams in a serial-to-parallel converter (SPC) 402. A modulation mapper 404 maps the two data streams to QPSK complex symbols. Multipliers 408 and 406 spread the QPSK complex symbols with an OVSF code C_{sch cont} at a chip rate. A complex symbol sequence I+jQ is produced out of the spread signals in a phase shifter 410 and a summer 412. A scrambler 414 scrambles the complex symbol sequence with a scrambling code S_{sch cont}. The scrambled signal is pulse-shaped in a pulse shaping filter 416, converted to an RF signal in an RF module 418, and then transmitted to UEs through an antenna 420.

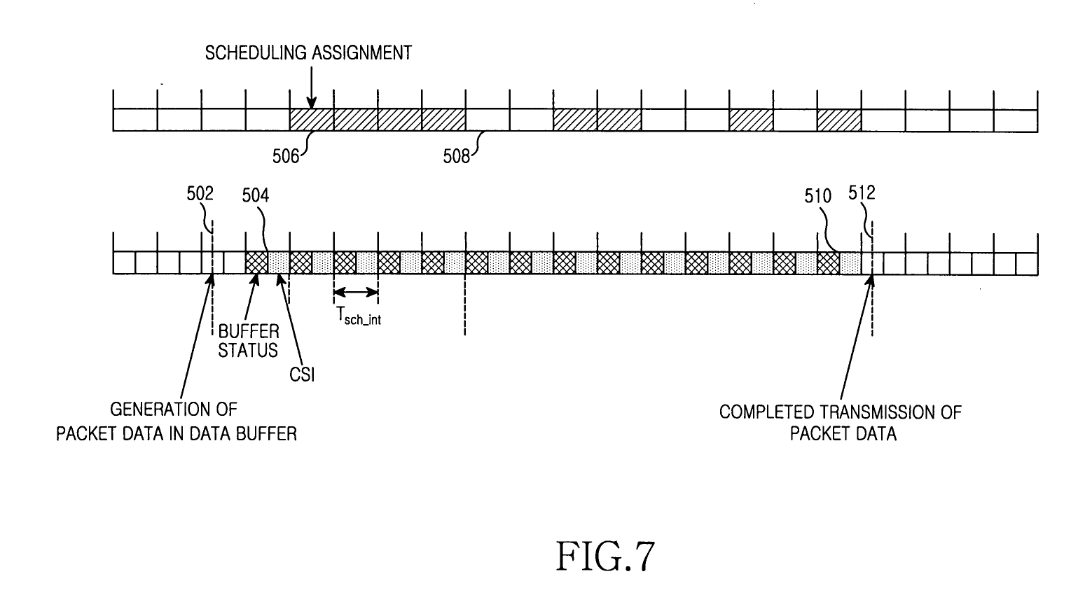

FIG. 7 illustrates transmission of buffer status information and a CSI from the UE to the Node B in order to enable the Node B to schedule uplink packet data transmission until all packet data buffered in a data buffer of the UE is transmitted. The CSI refers to an uplink transmit power or an uplink transmit power margin.

Referring to FIG. 7, upon the generation of packet data in the data buffer at a time 502, the UE transmits scheduling information including buffer status information and a CSI to the Node B, starting from a scheduling interval 504, in order to request EUDCH scheduling. The Node B determines a maximum data rate for the UE based on the scheduling information and transmits a scheduling command including a scheduling grant message and the maximum data rate to the UE. If the ROT condition is not satisfied, the Node B does not grant uplink data transmission by excluding the UE from scheduling as at a time 508.

If the amount of buffered packet data of the UE exceeds a one time-transmittable size, the UE continuously requests scheduling to the Node B until the packet data is completely transmitted. Accordingly, the UE continuously transmits the buffer status information and the CSI for scheduling intervals 504 through 510. When the buffered packet data is completely transmitted at a time 512, the UE discontinues the transmission of the buffer status information and the CSI.

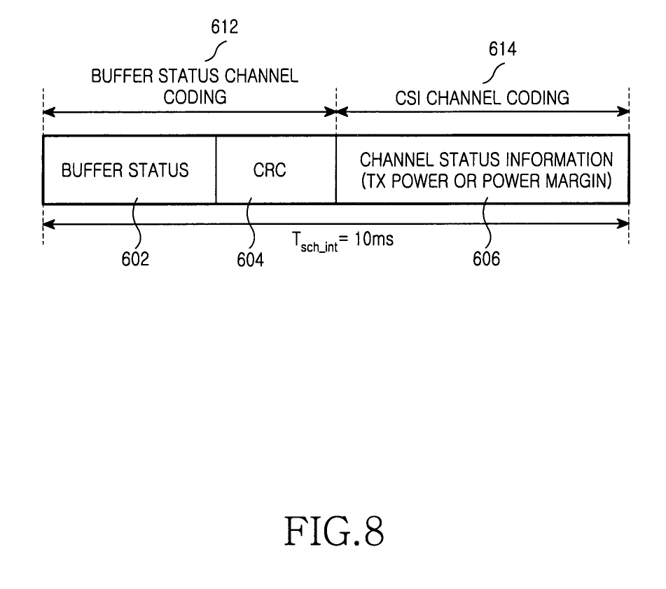

FIG. 8 illustrates the format of the scheduling information that the UE transmits for EUDCH scheduling of the Node B. In the illustrated case, the scheduling information is 10 ms in duration. Referring to FIG. 7, the scheduling information includes a Buffer Status 602 and a CSI 606 indicating an uplink transmit power or an uplink transmit power margin. Because the Buffer Status 602 and the CSI 614 may differ in terms of transmission cycle, they are channel-encoded separately, as indicated by reference numerals 612 and 614.

The Buffer Status 602 is not transmitted all the time. Therefore, the Buffer Status 602 is channel-encoded together with an associated CRC (Cyclic Redundancy Code) 604. The Node B determines if the scheduling information contains the Buffer Status 602 by a CRC check. Once the Node B detects the Buffer Status 602 in the CRC check, the Node B determines the position of the CSI 606. Accordingly, there is no CRC for the CSI 606.

In a preferred embodiment of the present invention, a TFCI indicating the TFs of transport channels is used to transmit EUDCH scheduling commands. For better understanding of the present invention, TFCIs will first be addressed herein below.

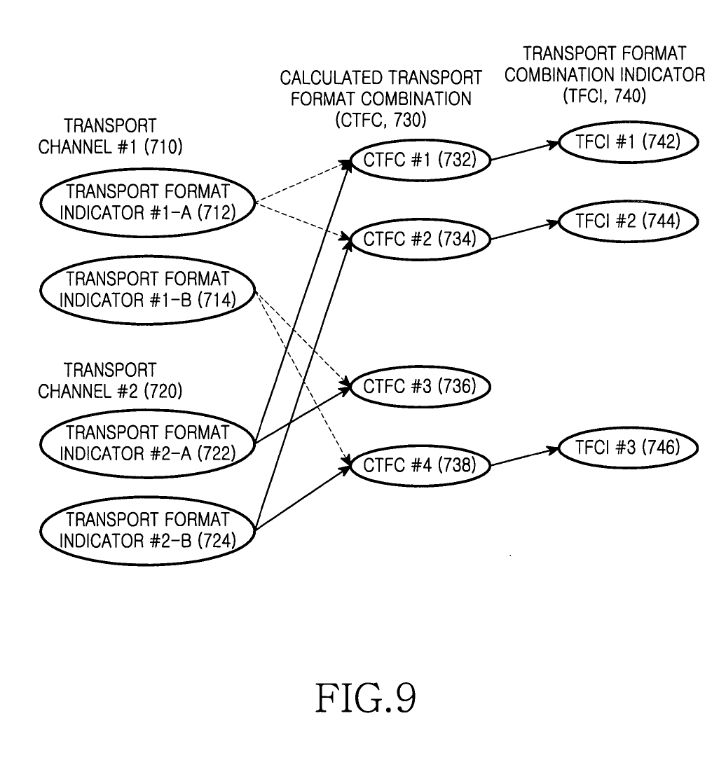

FIG. 9 illustrates formation of TFCIs from the TFs of transport channels. In FIG. 9, two transport channels 710 and 720 (transport channel #1 and transport channel #2) are mapped onto one physical channel. Two TFs 712 and 714 (TFI #1-A and TFI #1-B) are available to transport channel #1 and two TFs 722 and 724 (TFI #2-A and TFI #2-B) are available to transport channel #2. Either of the two TFs is actually used for one transport channel.

Referring to FIG. 9, four TFCs (Transport Format Combinations) can be produced out of the four TFs 712, 714, 722, and 724 of the transport channels 710 and 720. The four TFCs are collectively called a CTFC (Calculated Transport Format Combination) group 730. For example, a CTFC 732 (CTFC #1) represents using TFI #1-A for transport channel #1 and TFI #2-A for transport channel #2. In this manner, every possible TFC is calculated for the transport channels 710 and 720, resulting in the four CTFCs 732 to 738.

In real transmission, all the CTFCs are not used. If CTFC #3 is not used, only the CTFCs 732, 734, and 738 are labeled with TFCIs (Transport Format Combination Indicators) 742, 744, and 746 (TFCI #1, TFCI #2 and TFCI #3). That is, TFCI #1, TFCI #2, and TFCI #3 are assigned to CTFC #1, CTFC #2, and CTFC #4 respectively, except CTFC #3.

The thus-constructed TFCIs are preserved commonly in the Node B and the UE by higher layer signaling. That is, the Node B and the UE have knowledge of the relationship between the TFCIs and the TFs of the transport channels. A transmitter selects appropriate TFs for data transmission on a physical channel and transmits TFCI bits indicating the selected TFs to a receiver. The transmitter and the receiver sides can be the Node B and the UE respectively, or vice versa.

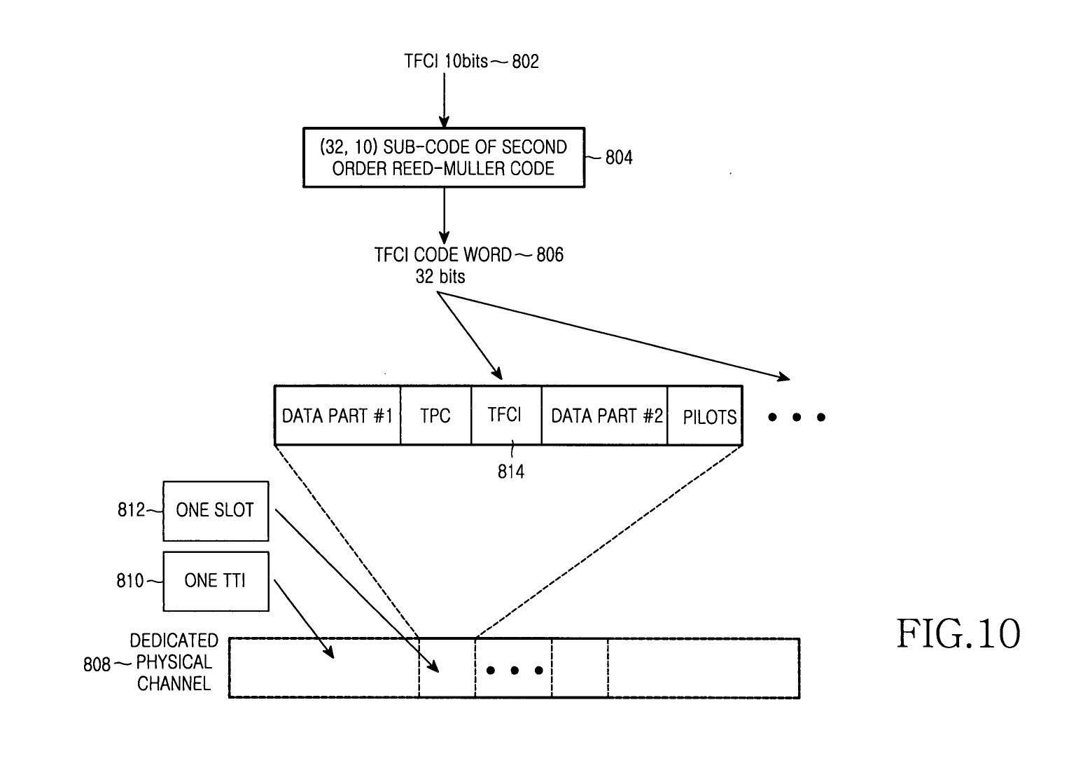

FIG. 10 illustrates transmission of TFCIs formed in the manner illustrated in FIG. 9 on a physical channel. Referring to FIG. 10, the transmitter selects appropriate TFs for data transmission on transport channels and determines a TFCI indicating a combination of the TFs. If the TFCI is shorter than a predetermined transmission size, e.g., 10 bits, the transmitter creates TFCI information 802 padded with as many zeroes as necessary, and encodes the TFCI information 802 with a predetermined channel code 804, thereby producing a 32-bit TFCI codeword 806. The TFCI codeword 806 is carried in the TFCI or TFCI fields of at least one slot 812 within one TTI (Transmission Time Interval) of a physical channel 808.

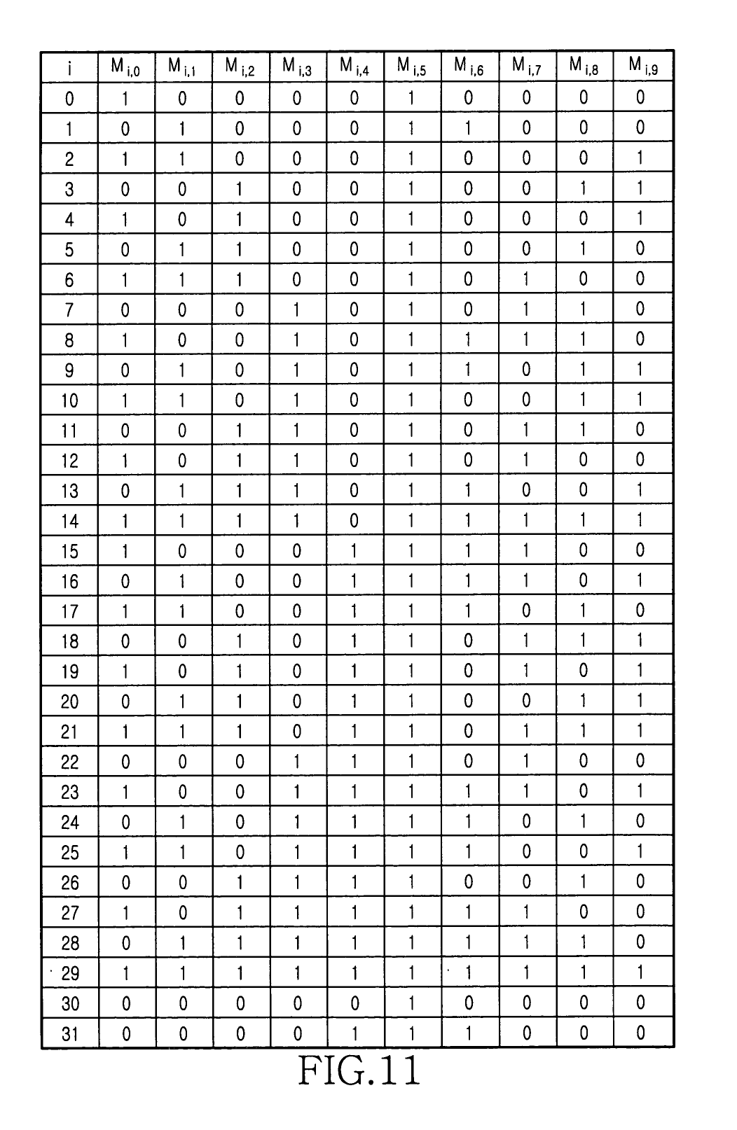

In a preferred embodiment of the present invention, the channel code 804 is a second-order Reed-Muller code. If the 10-bit TFCI information 802 is denoted by TFCI BIT_n, n=0, . . . , 9, the 32-bit TFCI codeword 804 is then determined by Equation (1):
CODEWORD_{TFCl}#i=ₙ^{Σ}(TFCI BIT_{—}n×M_{i,n})mod2 (1)
where i is a codeword index ranging from 0 to 31 and M_{i,n} is a base sequence available for channel encoding of the TFCI. Such base sequences are illustrated in FIG. 11.

FIG. 11 illustrates a table listing 10-bit base sequences with respect to 32 available i values.

In accordance with a preferred embodiment of the present invention, a TFCI involving a virtual transport channel is used to deliver a scheduling command to each UE using the EUDCH service (hereinafter, referred to as an EUDCH UE). An RNC (Radio Network Controller), which controls a service between the Node B and the UE, establishes the virtual transport channel for delivering the scheduling command at an EUDCH setup. The virtual transport channel does not deliver actual information, but the TFCI involving the virtual transport channel is used to transmit the EUDCH scheduling command.

In an embodiment of the present invention, four TFs whose meanings are related to a maximum EUDCH data rate are available to the virtual transport channel: “UP”, “No Change”, “Down”, and “Tx Suspend”.

As described above, the EUDCH UE transmits EUDCH data together with its TFRI. A plurality of available data rates are preset for transmission of the EUDCH data and the data rate of the EUDCH data is incremented or decremented by one level at each transmission.

The TFRI represents a predetermined number of TFs used for the EUDCH service, or the TFC of a plurality of transport channels. In accordance with an embodiment of the present invention, a TFRI list is made in which available uplink TFRI values are arranged with respect to data rates or transmit power levels, and a downlink TFCI is used to command “UP”, “No Change”, “Down”, or “Tx Suspend” regarding the TFRI. Accordingly, the uplink data rate is controlled.

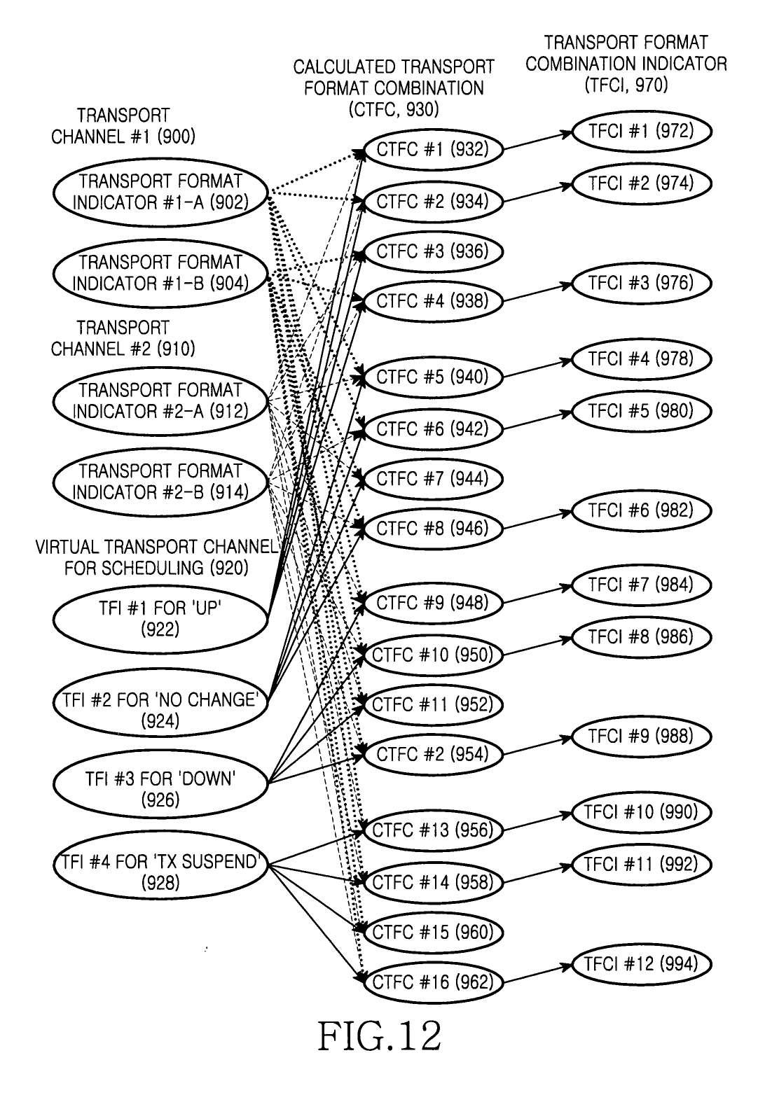

FIG. 12 illustrates a formation of TFCI information involving the virtual transport channel for delivering a scheduling command according to a preferred embodiment of the present invention. Similarly to TFCI formation illustrated in FIG. 9, two transport channels 900 and 910 (transport channel #1 and transport channel #2) are mapped onto one physical channel, each having two TFs 902 and 904 (TFI #1-A and TFI #1-B) or 912 and 914 (TFI #2-A and TFI #2-B). In addition, a virtual transport channel 920 for delivering a scheduling command is mapped onto the physical channel. Reference numeral 903 denotes a CTFC group for the transport channels 900, 910, and 920. Reference numeral 970 denotes a group of TFCIs available to the transport channels 900, 910, and 920 in real implementation.

Referring to FIG. 12, four TFs 922, 924, 926, and 928 (TFI #1 for Up, TFI #2 for No Change, TFI #3 for Down, and TFI #4 for Tx Suspend) are available to the virtual transport channel 920. Tx Suspend indicates that uplink data transmission is not approved.

The CTFC group 930 contains a total of 16 CTFCs ranging from a first CTFC 923 (CTFC #1) made up of TFI #1-A for transport channel #1, TFI #2-A for transport channel #2, and TFI #1 for the virtual transport channel to a 16^{th} CTFC 962 (CTFC #16) made up of TFI #1-B for transport channel #1, TFI #2-B for transport channel #2, and TFI #4 for the virtual transport channel.

Assuming that TFI #1-B and TFI #2-A are excluded, the remaining CTFCs 932, 934, 938, 940, 942, 946, 948, 950, 954, 956, 958, and 962, not including CTFC #3, CTFC #7, CTFC #7, CTFC #11, and CTFC #15 form the TFCI group 970. Consequently, the TFCI group 970 has a total of 12 TFCIs 972 to 994 ranging from TFCI #1 to TFCI #12.

While the TFs of the virtual transport channels are defined as Up, No Change, Down, and Tx Suspend in the embodiment of the present invention illustrated in FIG. 12, it can be further contemplated as another embodiment that three TFs, “Tx”, “No Change”, and “Tx Suspend” are defined for the virtual transport channel, “Tx” commanding an increase in the TFRI corresponding to a maximum data rate on the TFRI list, and “Tx Suspend” commanding a one-level decrease in the TFRI. The UE determines the data rate of the EUDCH at or below the maximum data rate corresponding to the TFRI.

A third embodiment of the present invention can be contemplated by defining the TFs of the virtual transport channel as “2-level Increase”, “1-level Increase”, “No Change”, “2-level Decrease”, “1-level Decrease”, and “Tx Suspend” so that TFRIs arranged in an order of data rate or transmit power can be adjusted by at least two levels at one time. Therefore, the Node B can control the EUDCH data rate more freely.

In another embodiment of the present invention, TFs indicating all available EUDCH data rates can be set for the virtual transport channel. Therefore, the number and meanings of the TFs of the transport channel are not limited to the above-described details and vary depending on designer settings.

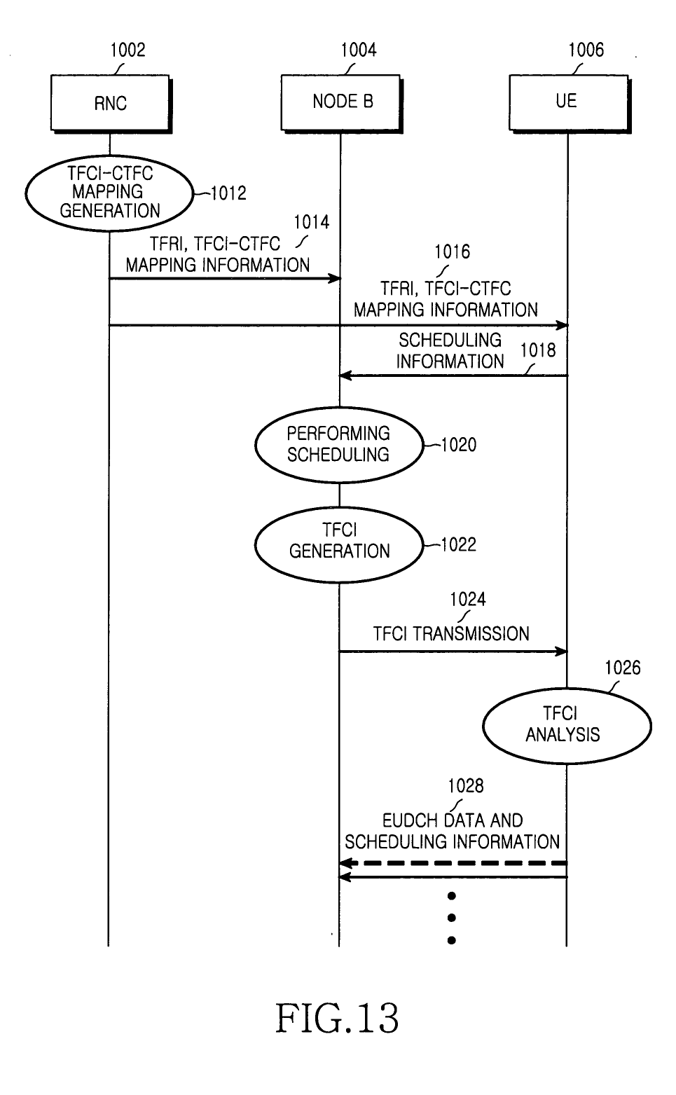

FIG. 13 is a diagram illustrating a signal flow for transmitting an EUDCH scheduling command by a TFCI according to a preferred embodiment of the present invention. Referring to FIG. 13, in step 1012, an RNC 1002 generates information about the mapping relationship between CTFCs and TFCIs using the TFs of transport channels, as illustrated in FIG. 12. The RNC 1002 signals a TFRI list and the CTFC-TFCI mapping list to a Node B 1004 and a UE 1006 in steps 1016 and 1018. The Node B 1004 and the UE 1006 identify the TFs of transport channels corresponding to each CTFC by the TFRI list and select/perceive TFCIs by the CTFC-TFCI mapping list.

In step 1018, the UE 1006 transmits, to the Node B 1004, scheduling information including buffer status information and a CSI on an EU-DPCCH. The Node B 1004 then analyzes the scheduling information and schedules uplink data transmission based on the scheduling information in step 1020. The Node B 1004 generates a TFCI, which involves the TF of a virtual transport channel indicating a scheduling command based on the scheduling result in step 1022 and transmits the TFCI to the UE 1006 in step 1022.

The UE 1006 obtains the scheduling command by analyzing the TFCI and determines whether to transmit EUDCH data for the next TTI and an EUDCH data rate if the EUDCH data is to be transmitted in step 1026. If the TFCI approves uplink data transmission for the UE 1006, the UE 1006 transmits the EUDCH data and scheduling information on an EU-DPDCH and the EU-DPCCH, respectively, in step 1028. Steps 1020 through 1028 are repeated for every EUDCH TTI.

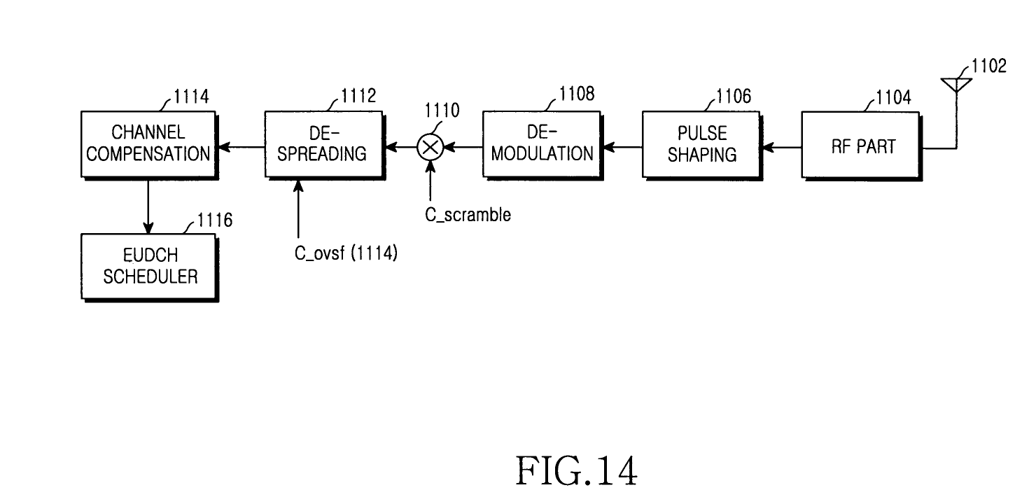

FIG. 14 is a block diagram of a receiver in the Node B, for receiving the scheduling information on the EU-DPCCH from the UE according to a preferred embodiment of the present invention. Referring to FIG. 14, a signal received through a receive antenna 1102 is converted to a baseband signal in an RF module 1104 and a pulse shaping filter 1106. A demodulator 1108 demodulates the baseband signal and extracts the I channel signal including the EU-DPCCH signal. The I channel signal is descrambled with a scrambling code C_scramble in a descrambler 1110 and despread with an OVSF code, C_ovsf, in a despreader 1112. A channel compensator 1114 compensates the despread signal for its distortion. The channel-compensated signal has EUDCH scheduling information including buffer status information of the UE and thus is provided to an EUDCH scheduler 1116.

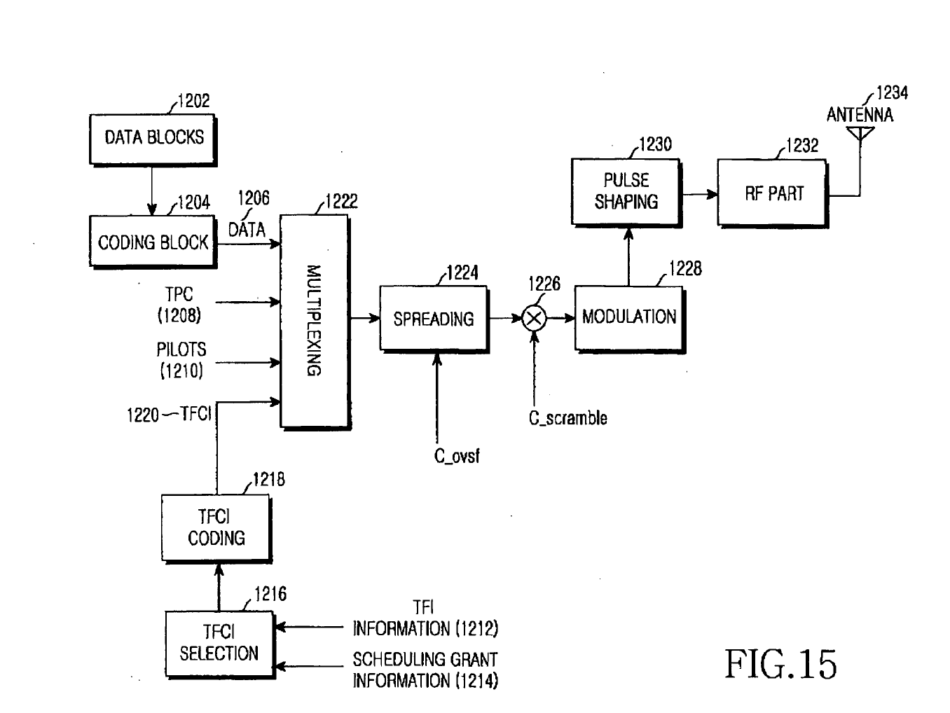

FIG. 15 is a block diagram of a transmitter in the Node B, for transmitting TFCI information superimposed with an EUDCH scheduling command according to a preferred embodiment of the present invention. That is, without affecting the original function of TFCI, a certain available pattern of TFCI is designed to be used for the scheduling command in the present invention. As described above, the WCDMA system transmits a data block, TPC (Transmission Power Control) information, a pilot signal, and TFCI information in time division on the downlink.

Referring to FIG. 15, downlink data blocks 1202 are encoded in an encoder such as coding block 1204. For the input of the TFI 1212 of each transport channel and scheduling grant information 1214, a TFCI selector 1216 selects a TFCI. The TFIs 1212 indicate the TFs of different transport channels and the scheduling grant information 1214 indicates the TF of the virtual transport channel. Therefore, the TFCI selector 1216 selects the TFCI involving all of the TFIs 1212 and the scheduling grant information 1214, referring to mapping relationship information as illustrated in FIG. 12. The TFCI is encoded in a channel encoder such as the TFCI coding block 1218.

A multiplexer (MUX) 1222 multiplexes the coded data blocks 1206 received from the coding block 1204, the coded TFCI 1220 received from the TFCI coding block 1218, and at least one pilot signal 1210. The multiplexed signal is spread with the OVSF code, C_ovsf, at a chip rate in a spreader 1224 and scrambled with the scrambling code C_scramble in a multiplier 1226. After processing in a modulator 1228 and a pulse shaping filter 1230, the scrambled signal is converted to an RF signal in an RF part 1232 and transmitted through an antenna 1234.

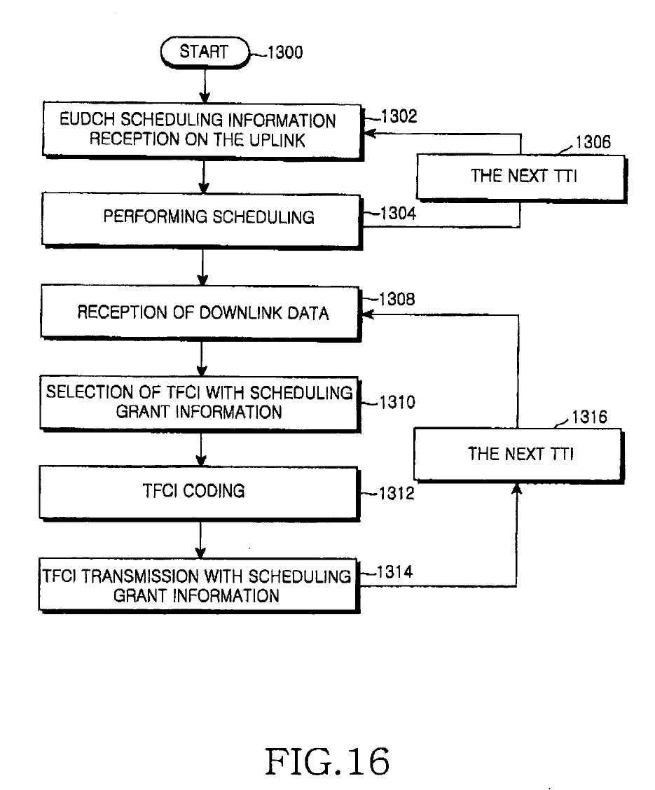

FIG. 16 is a flowchart illustrating an operation for transmitting scheduling grant information by a TFCI in the Node B according to a preferred embodiment of the present invention. Referring to FIG. 16, when the EUDCH service starts in step 1300, the Node B receiver configured as illustrated in FIG. 14 receives EUDCH scheduling information including buffer status information of the UE on the EU-DPCCH in step 1302, schedules uplink data transmission for the current TTI based on the scheduling information in step 1304, and receives uplink data on the EU-DPDCH in the next TTI in step 1306.

In step 1308, data blocks destined for the UE arrive at the Node B from a higher layer system. The Node B transmitter configured as illustrated in FIG. 15 selects a TFCI according to an appropriate TF for the data blocks and scheduling grant information for the UE in step 1310. The TFCI is encoded in step 1312 and transmitted in step 1314. In step 1316, the Node B proceeds to the next TTI and repeats step 1308 through step 1314.

While it has been described above that the Node B selects a TFCI after receiving downlink data blocks directed to the UE, the Node B proceeds to step 1310 and selects the TFCI even in the absence of downlink data.

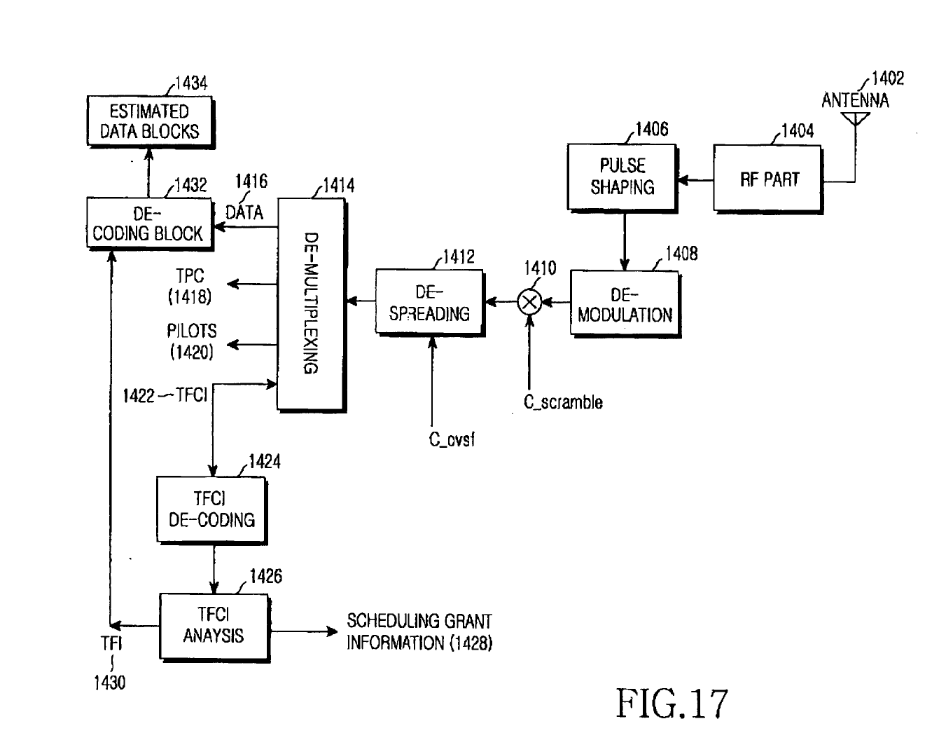

FIG. 17 is a block diagram of a receiver in the UE, for receiving a TFCI on the downlink according to a preferred embodiment of the present invention. The UE receiver is the counterpart of the Node B transmitter illustrated in FIG. 15.

Referring to FIG. 17, an RF signal received on the downlink through a receive antenna 1402 is converted to a baseband signal through frequency down conversion in an RF part 1404, pulse shaped in a pulse shaping filter 1406, and demodulated in a demodulator 1408. The baseband signal is descrambled with the scrambling code C_scramble in a multiplier 1410 and despread with the OVSF code, C_ovsf, in a despreader 1412.

A demultiplexer (DEMUX) 1414 demultiplexes the despread signal into a data part 1416, a TPC signal 1418, at least one pilot signal 1420, and a TFCI 1422. The TFCI 1422 is provided to a TFCI analyzer 1426 through a decoder 1424. The TFCI analyzer 1426 extracts TFI information 1430 representing the TFs of transport channels and EUDCH scheduling grant information 1428 by analyzing the decoded TFCI. The EUDCH scheduling grant information 1428 indicates a maximum data rate set by the Node B. A decoder 1432 decodes the data part 1416 using the TFI information 1430, thereby obtaining estimated data blocks 1434. The estimated data blocks 1434 are interpreted as packet data in a higher layer.

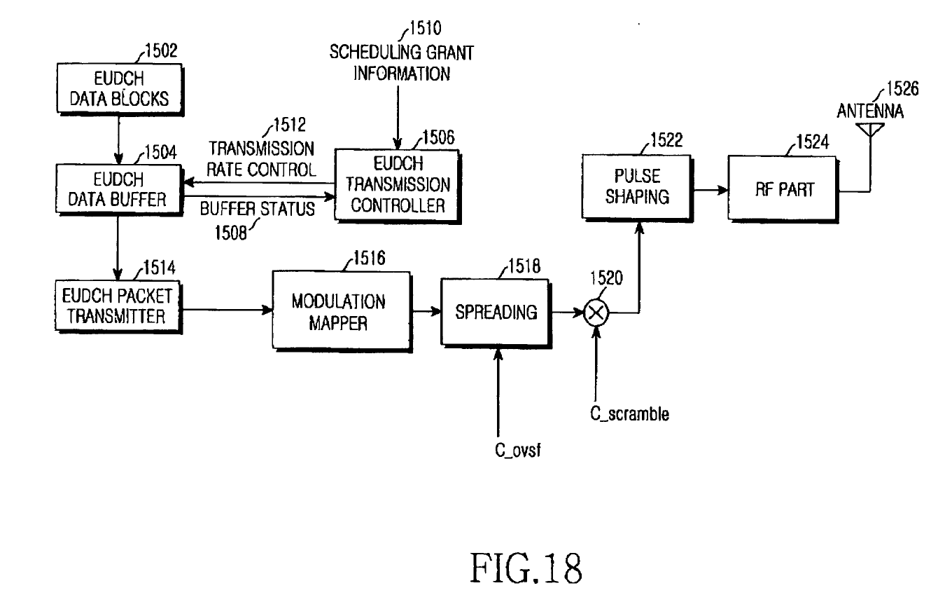

FIG. 18 is a block diagram of a transmitter in the UE, for transmitting EUDCH data blocks on the uplink using scheduling grant information acquired from a TFCI according to a preferred embodiment of the present invention. Referring to FIG. 18, the physical layer of the UE, for which the EUDCH service is set up, receives EUDCH data blocks 1502 from a higher layer and buffers them in a data buffer 1504, for transmission on the EUDCH. The buffer 1504 reports its status 1508 to an EUDCH transmission controller 1506. The buffer status 1508 represents the amount of the buffered data.

The EUDCH transmission controller 1506 transmits to the buffer 1504 a rate control command 1512 commanding a predetermined amount of data set according to a maximum data rate indicated by the scheduling grant information 1510 (1428 in FIG. 17) received from the receiver illustrated in FIG. 17. The buffer 1504 then transmits the amount of data to an EUDCH packet transmitter 1514 in response to the rate control command 1512.

The EUDCH packet transmitter 1514 encodes the data in an available TF and a modulation mapper 1516 modulates the coded data in BPSK, QPSK, or 8PSK. The modulated signal is spread with the OVSF code C_ovsf at a chip rate in a spreader 1518 and scrambled with the scrambling code C_scramble in a multiplier 1520. The scrambled signal is transmitted to a transmit antenna 1526 through a pulse shaping filter 1522 and an RF part 1524.

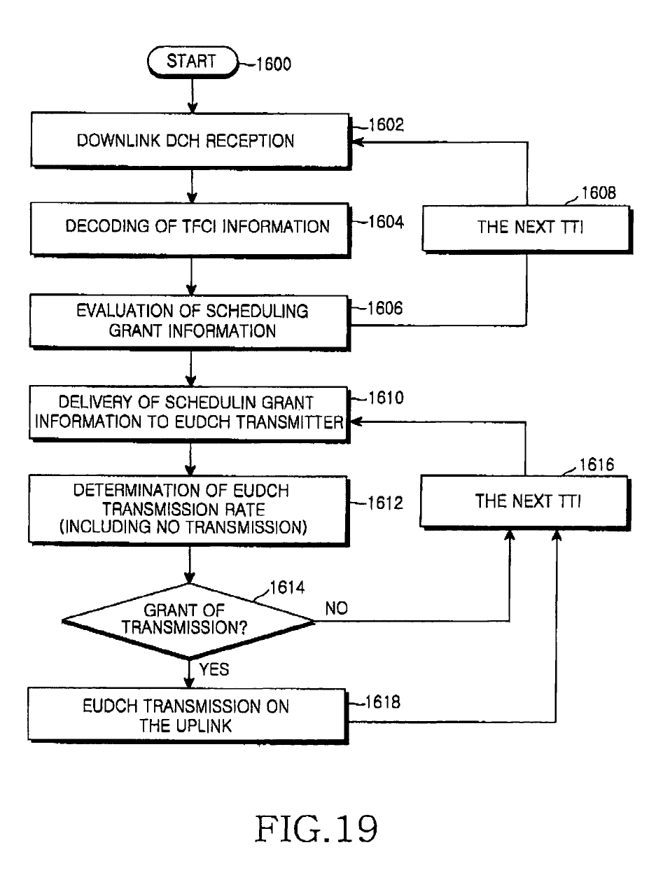

FIG. 19 is a flowchart illustrating an operation for transmitting EUDCH data blocks based on the scheduling grant information acquired from the TFCI in the physical layer of the UE according to a preferred embodiment of the present invention. Referring to FIG. 19, as the EUDCH service starts in step 1600, the UE receiver configured as illustrated in FIG. 17 receives a DCH signal on the downlink in step 1602. The DCH signal has been descrambled with a scrambling code allocated to the DCH. TFCI information is extracted from the DCH signal in step 1604 and scheduling grant information is acquired from the TFCI information in step 1606. When the next TTI comes in step 1608, the UE receiver returns to step 1602. Step 1602 through step 1606 are repeated every TTI.

In step 1610, the scheduling grant information is provided to the UE transmitter configured as illustrated in FIG. 18. The transmitter determines a maximum data rate available to the next TTI based on the scheduling grant information in step 1612. If transmission is suspended in the next TTI according to the scheduling grant information, the maximum data rate is set to a minimum one or zero.

In step 1614, the transmitter determines from the maximum data rate if the uplink transmission is allowed. If the uplink transmission is allowed, the transmitter performs EUDCH transmission on the uplink in step 1618. However, if the uplink transmission is not allowed, no EUDCH data is transmitted in the next TTI. Step 1610 through step 1618 are repeated every TTI as done in step 1616.

While a TFCI is formed by combining the TF of the virtual transport channel for delivering scheduling grant information with the TFs of other transport channels in the above description, another embodiment can be contemplated in which a TFCI for EUDCH scheduling is configured separately from the TFCI of other transport channels. In this case, the EUDCH scheduling TFCI may involve the TF of the virtual transport channel, or the TFs of the virtual transport channel and another downlink channel for EUDCH.

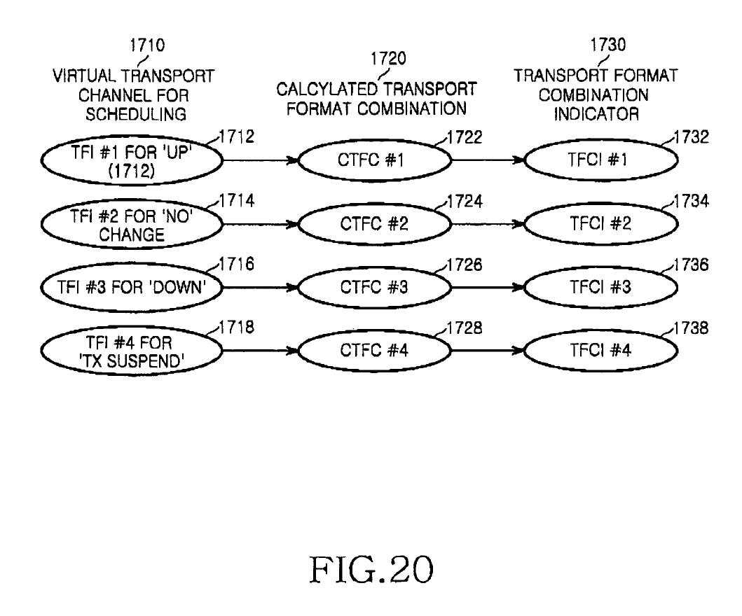

FIG. 20 illustrates formation of TFCIs by which the Node B transmits scheduling grant information to the UE according to another preferred embodiment of the present invention. The TFCI for EUDCH scheduling represents only the TF of the virtual transport channel.

Referring to FIG. 20, four TFIs 1712, 1714, 1716, and 1718 (TF #1 for Up, TFI #2 for No Change, TFI #3 for Down, and TFI #4 for Tx Suspend) are defined for a virtual transport channel 1710 for EUDCH scheduling. Because the virtual transport channel 1710 only is involved in forming such a TFCI, a CTFC group 1720 contains CTFCs 1722, 1724, 1726, and 1728 (CTFC #1 to CTFC #4) corresponding to the TFIs 1712 to 1718. Therefore, a TFCI group 1730 for EUDCH is made up of TFCIs 1732, 1734, 1736, and 1738 (TFCI #1 to TFCI #4) representing the CTFCs 1722 to 1728 in a one-to-one correspondence.

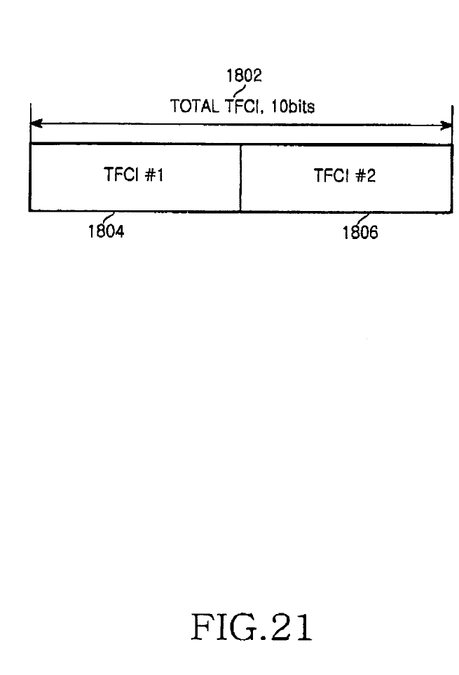

FIG. 21 illustrates combining of the TFCI of the virtual transport channel used for EUDCH scheduling with that of other transport channels according to a preferred embodiment of the present invention. Referring to FIG. 21, a 10-bit TFCI field 1802 is divided into TFCI #1 and TFCI #2 fields 1804 and 1806. These two TFCI fields are filled with different TFCIs for other transport channels and the virtual transport channel. For example, the TFCI of other transport channels is allocated to the TFCI #1 field 1804, whereas that of the virtual transport channel to the TFCI #2 field 1806.

The sizes of the two fields 1804 and 1806 are determined within the total of 10 bits by a signaling procedure for TFCI setting. The sizes are flexibly set, ranging from 1-bit TFCI #1 and 9-bit TFCI #2 to 9-bit TFCI #1 and 1-bit TFCI #2. The full TFCI field 1802 is transmitted and received in the transmitter illustrated in FIG. 15 and the receiver illustrated in FIG. 17. Because the TFCI fields 1804 and 1806 are variable in length, they are channel-encoded separately.

ACK/NACK Transmission

However, before describing ACK/NACK transmission by a TFCI according to a preferred embodiment of the present invention, a conventional ACK/NACK transmission on a separate channel will first be described.

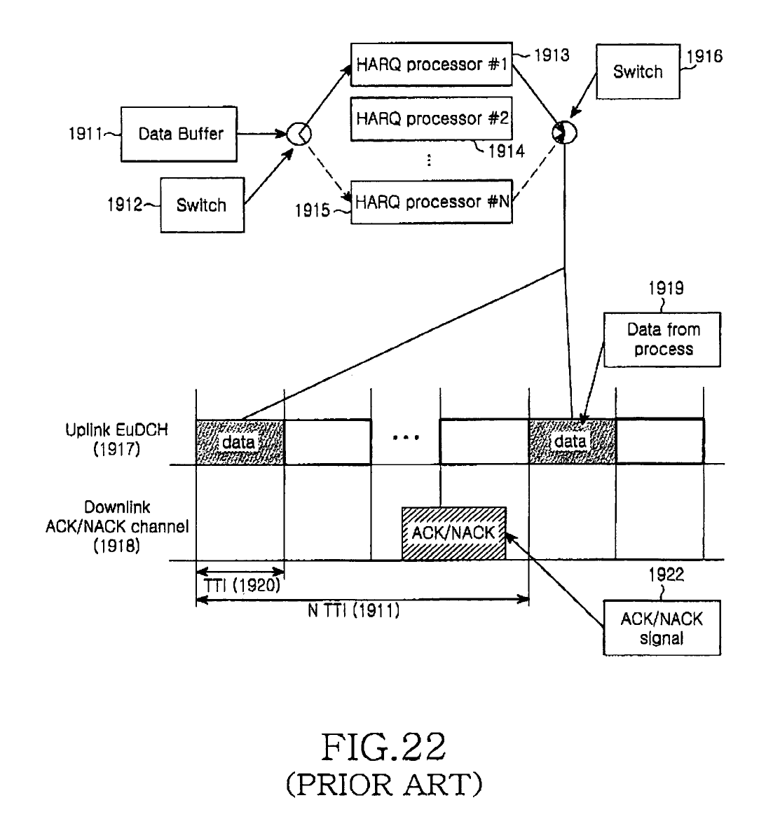

FIG. 22 conceptually illustrates packet transmission by HARQ from the UE to the Node B. Referring to FIG. 22, the UE stores packet data blocks received from a higher layer in a buffer 911. The buffer 911 distributes the packet data blocks to HARQ processors 1913 to 1915 (HARQ processor #1 to HARQ processor #N) by means of a switch 1912. The number of the HARQ processors 1913 to 1915 is determined considering a time delay involved in a data transmission and a response between the UE and the Node B. For example, data blocks 1919 output from HARQ processor #1 are transmitted for one TTI 220 of an EUDCH 1917 through a switch 1916. For the following TTI, data blocks from another HARQ processor are transmitted. An ACK/NACK signal 1922 is fed back within N TTIs 1911 on an ACK/NACK channel 1918, notifying if the data blocks 1919 from HARQ processor #1 have been received successfully in the Node B.

The ACK/NACK signal on the downlink is information for determining whether retransmission of the transmitted data blocks is required or not. The ACK/NACK signal is relatively important compared to data blocks in that without the ACKINACK signal, unnecessary data blocks may be retransmitted or retransmission-required data blocks may not be retransmitted. Therefore, the ACK/NACK signal is transmitted at a lower rate that that of the data blocks, to thereby cope with errors.

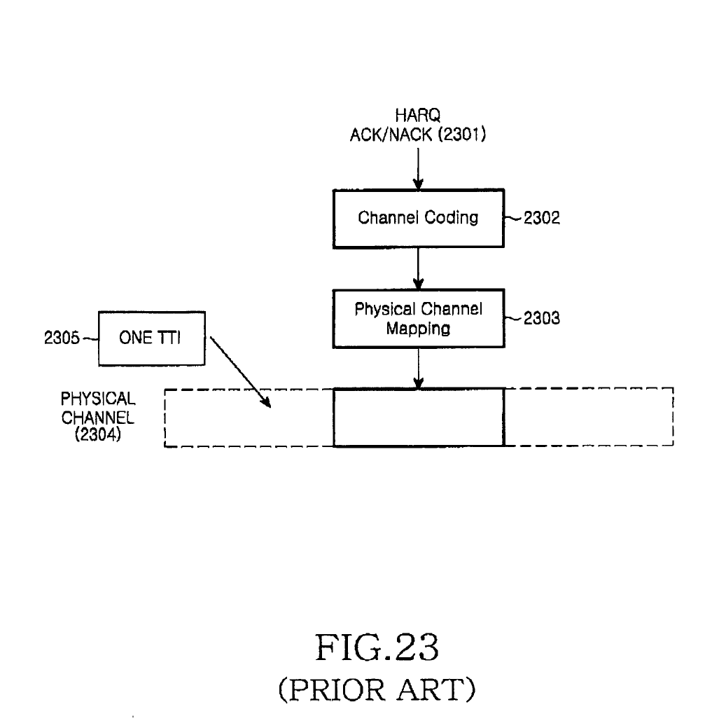

FIG. 23 illustrates ACK/NACK transmission on the ACK/NACK channel. Referring to FIG. 23, a 1-bit ACK/NACK signal 2301 is channel-encoded, taking into account the significance level of other data information in step 2302. In the channel encoding, the ACK/NACK signal 2301 may be repeated to a plurality of bits. Also, the ACK/NACK signal 2301 can be encoded with a predetermined channel code. The coded ACK/NACK signal containing a predetermined number of symbols is allocated to one TTI 2305 of a physical channel 2304 through physical channel mapping in step 2303.

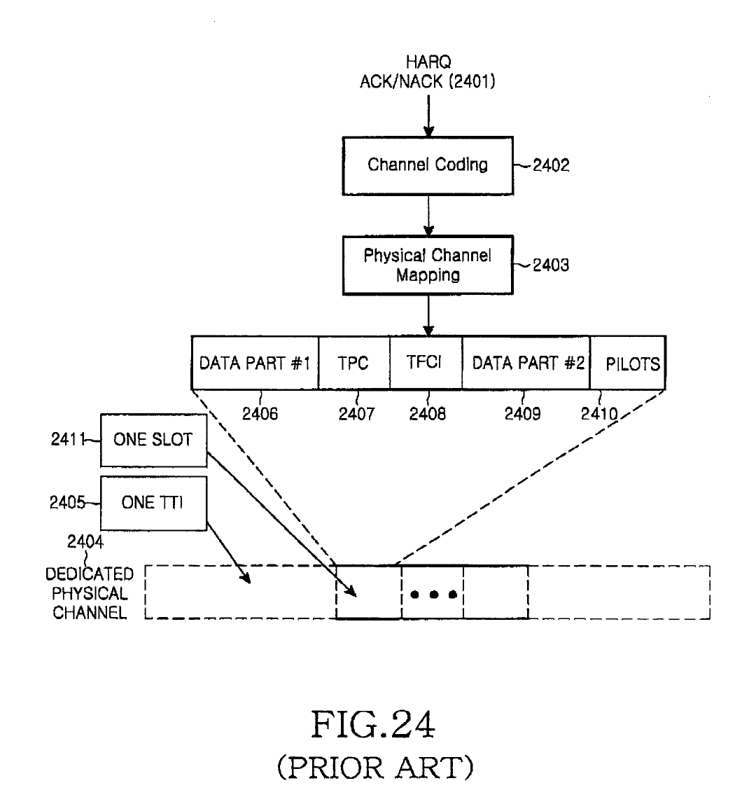

FIG. 24 illustrates ACK/NACK transmission on a dedicated physical channel. Referring to FIG. 24, a 1-bit ACK/NACK signal 2401 is allocated to one TTI 2405 of a dedicated physical channel 2404 through channel encoding 2402 and physical channel mapping 2403 as illustrated in FIG. 23. The dedicated physical channel 2404 may include one or more slots 2411 within one TTI 2405 on the downlink in the WCDMA system. Each slot is divided into five parts, which includes two data parts 2406 and 2409 (Data Part #1 and Data Part #2) for delivering user data or higher-layer control data, a TPC 2407 for transmit power control, a TFCI 2408 for indicating the TFs of the uplink, and Pilots 2410 for delivering a pilot signal by which channel condition is estimated. After the channel mapping 2403, the ACK/NACK symbols are allocated to the whole slots of the dedicated physical channel 2404, or partially punctured and mapped to a predetermined area in the dedicated physical channel 2404.

As will be described herein below, the present invention utilizes a virtual transport channel to efficiently transmit an ACK/NACK signal associated with the EUDCH on the downlink. A TFCI involving the ACK/NACK is set for the virtual transport channel. The virtual transport channel refers to a transport channel, which does not carry actual data, and its TFCI represents the ACK/NACK for the EUDCH. Two TFs are available to the virtual transport channel: TFI #1 for ACK and TFI #2 for NACK, or vice versa. Herein, TFI #1 is used for ACK and TFI #2 for NACK.

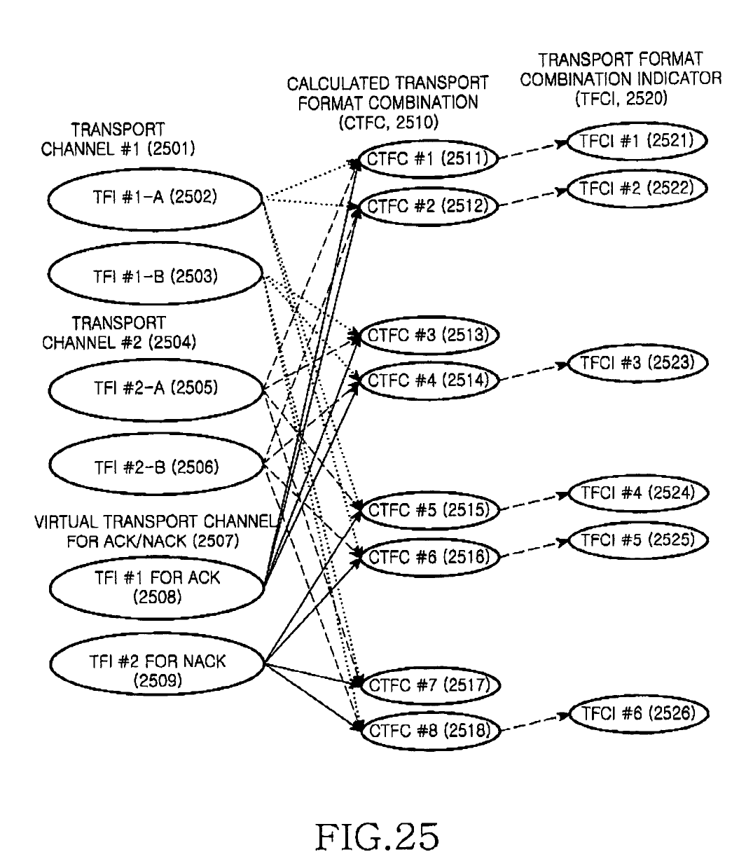

FIG. 25 illustrates formation of TFCI information involving a virtual transport channel according to a third preferred embodiment of the present invention. Referring to FIG. 25, two transport channels 2501 and 2504 (transport channel #1 and transport channel #2) are mapped onto one physical channel. Two TFs 2502 and 2503 (TFI #1-A and TFI #1-B) are available to transport channel #1 and two TFs 2505 and 2506 (TFI #2-A and TFI #2-B) are available to transport channel #2. A virtual transport channel 2507 is additionally mapped in order to indicate whether retransmission of packet data transmitted on the uplink is required or not. Reference numeral 2510 denotes a CTFC group for the transport channels 2501, 2504 and 2507. Reference numeral 2520 denotes a TFCI group containing TFCIs available to the transport channels 2501, 2504, and 2507 in real implementation. Two TFs 2508 and 2509 (TF #1 and TF #2) are available to the virtual transport channel 2507. TF #1 is an ACK indicating successful reception of packet data and TF #2 is an NACK indicating failed reception of packet data.

In relation to TF #1 for an ACK, the CTFC group 2510 contains 4 CTFCs ranging from a first CTFC 2521 (CTFC #1) made up of TFI #1-A for transport channel #1, TFI #2-A for transport channel #2, and TFI #1 for the virtual transport channel to a 4^{th} CTFC 2514 (CTFC #4) made up of TFI #1-B for transport channel #1, TFI #2-B for transport channel #2, and TFI #1 for the virtual transport channel. The CTFCs 2510 to 2514 correspond to TFCIs 2521 to 2523 (TFCI #1, TFCI #2, and TFCI #3) containing TF #1 for ACK. For example, if CTFC #3 is excluded from use, the TFCIs 2521, 2522, and 2523 are allocated to only the remaining CTFCs 2511, 2512, and 2514, respectively.

In relation to TF #2 for a NACK, the CTFC group 2510 contains 4 CTFCs 2515 to 2518 ranging from a fifth CTFC 2525 (CTFC #5) made up of TFI #1-A for transport channel #1, TFI #2-A for transport channel #2, and TFI #2 for the virtual transport channel to an eighth CTFC 2518 (CTFC #8) made up of TFI #1-B for transport channel #1, TFI #2-B for transport channel #2, and TFI #2 for the virtual transport channel. The CTFCs 2515 to 2518 correspond to TFCIs 2524 to 2526 (TFCI #4, TFCI #5, and TFCI #6) containing TF #2 for a NACK. For example, if CTFC #7 is excluded from use, the TFCIs 2524, 2525, and 2526 are allocated to only the remaining CTFCs 2515, 2516, and 2518, respectively.

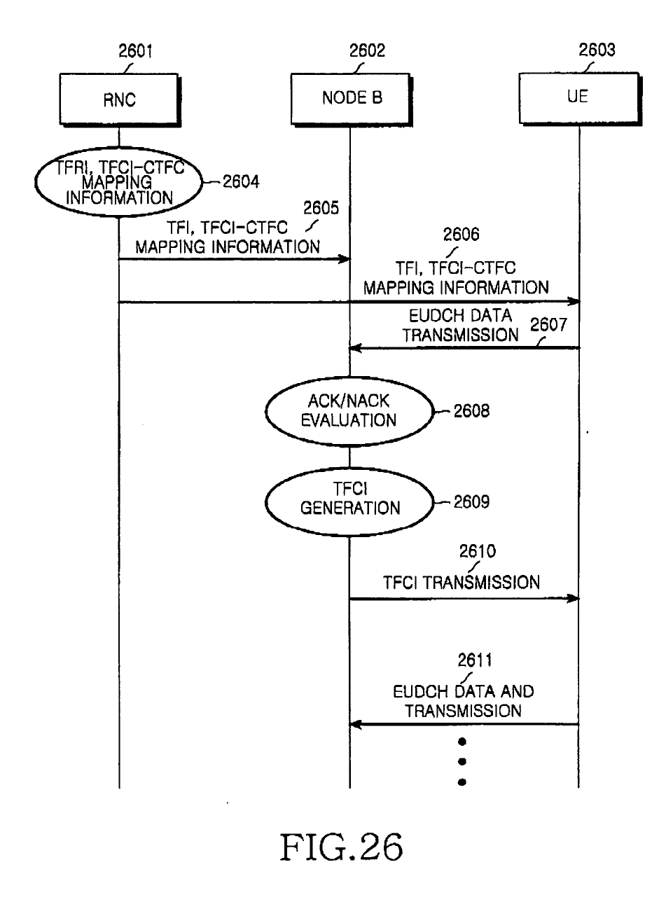

FIG. 26 is a diagram illustrating a signal flow for transmitting an ACK/NACK signal by a TFCI according to a preferred embodiment of the present invention. Referring to FIG. 26, an RNC 2601 generates information about the mapping relationship between CTFCs and TFCIs using the TFs of transport channels in step 2604. The RNC 2601 signals a TFRI list and the CTFC-TFCI mapping list to a Node B 2602 and a UE 2603 in steps 2605 and 2606. Thus, the Node B 2602 and the UE 2603 perceive the TFs of transport channels corresponding to each CTFC by the TFRI list and select/perceive TFCIs by the CTFC-TFCI mapping list.

In step 2607, the UE 2603 transmits data blocks on the EUDCH to the Node B 2602. The Node B 2602 checks errors in the received data blocks and generates an ACK/NACK signal according to the error check result in step 2608. The Node B 2602 generates a TFCI representing the ACK/NACK in step 2609 and transmits the TFCI to the UE 2603 in step 2609. In step 2611, the UE 2603 obtains the ACK/NACK by analyzing the TFCI, determines whether to transmit new EUDCH data or retransmit the transmitted EUDCH data for the next TTI, and transmits the new or previous EUDCH data. The Node B 2603 repeats step 2607 through step 2610 regarding the received EUDCH data.

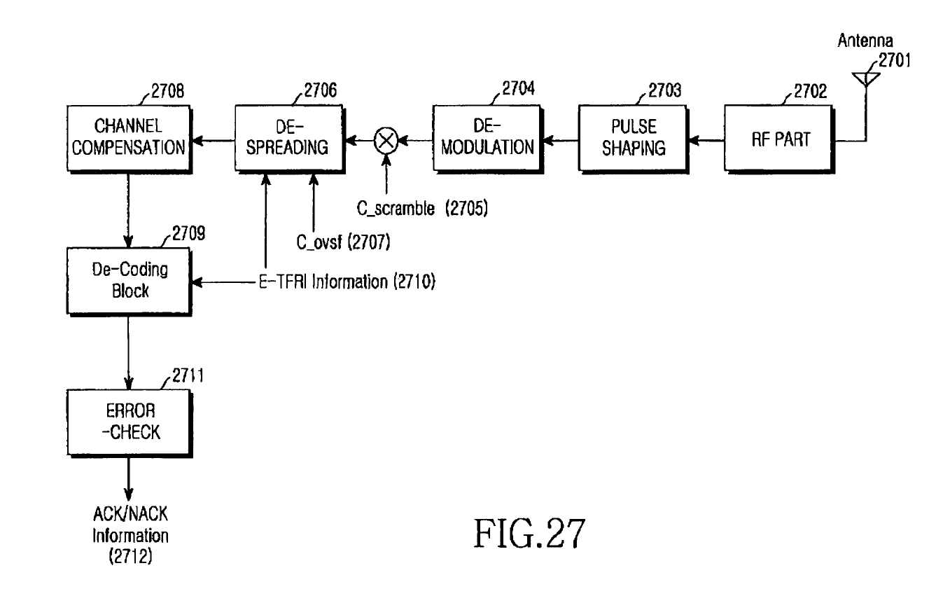

FIG. 27 is a block diagram of a receiver in the Node B, for generating an ACK/NACK signal according to EUDCH data blocks received on the uplink according to a preferred embodiment of the present invention. Referring to FIG. 27, a signal received through a receive antenna 2701 is converted to a baseband signal in an RF module 2702 and a pulse shaping filter 2703. A demodulator 2704 demodulates the baseband signal and extracts an I channel signal including an EU-DPCCH signal. The I channel signal is descrambled with the scrambling code C_scramble in a descrambler 2701 and despread with the OVSF code, C_ovsf, in a despreader 2706. A channel compensator 2708 compensates the despread signal for its distortion. A transmitted signal is estimated from the channel-compensated signal through channel encoding and de-rate matching in a decoder 2709. The despreader 2706 and the decoder 2709 use E-TFRI information 2710 acquired from a control channel, for channel estimation. An error checker 2711 checks errors in the estimated transmitted signal. An ACK/NACK signal 2712 is created according to the error check result.

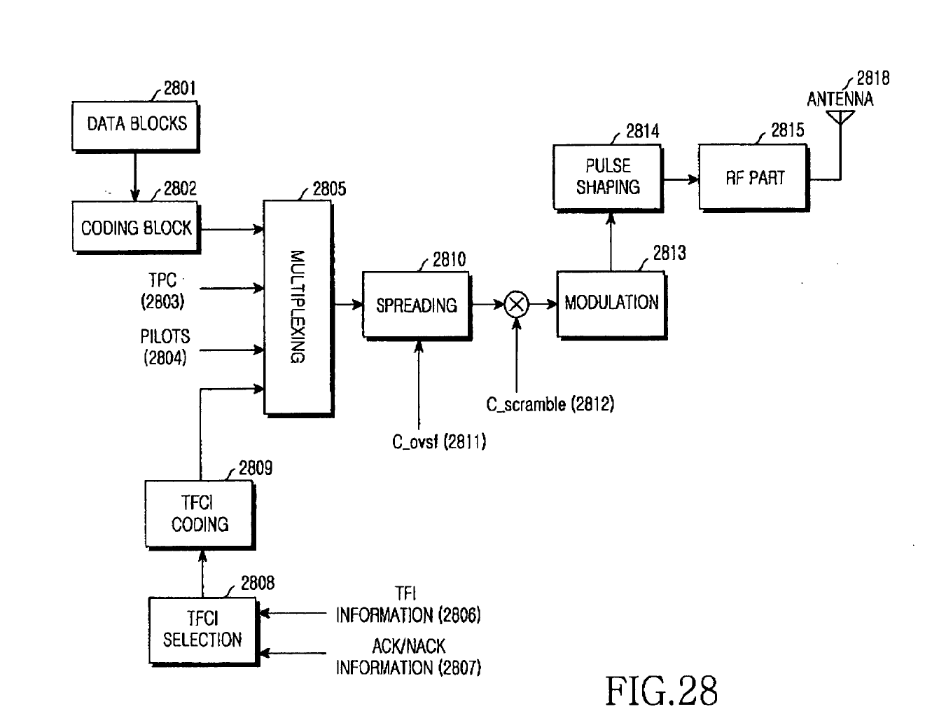

FIG. 28 is a block diagram of a transmitter in the Node B, for transmitting TFCI information superimposed with an ACK/NACK on the downlink according to a preferred embodiment of the present invention. As described above, the WCDMA system transmits a data block, TPC information, a pilot signal, and TFCI information in time division on the downlink.

Referring to FIG. 28, downlink data blocks 2801 are encoded in an encoder such as coding block 2802. For the input of the TFI 2806 of each transport channel and ACK/NACK information 2807, a TFCI selector 2808 selects a TFCI. The TFIs 2806 indicate the TFs of different transport channels and the ACK/NACK information 2807 indicates if retransmission of packet data is required, in correspondence with the TF of the virtual transport channel. Therefore, the TFCI selector 2808 selects a TFCI involving all of the TFIs 2806 and the ACK/NACK information 2807, referring to a mapping relationship list. The TFCI is encoded in a channel encoder 2809.

A MUX 2805 multiplexes the coded data blocks received from the coding block 2802, the coded TFCI received from the channel encoder 2809, and a pilot signal 2804. The multiplexed signal is spread with the OVSF code, C_ovsf, at a chip rate in a spreader 2801 and scrambled with the scrambling code C_scramble in a multiplier 2812.

After processing in a modulator 2813 and a pulse shaping filter 2814, the scrambled signal is converted to an RF signal in an RF part 2815 and transmitted through an antenna 2818.

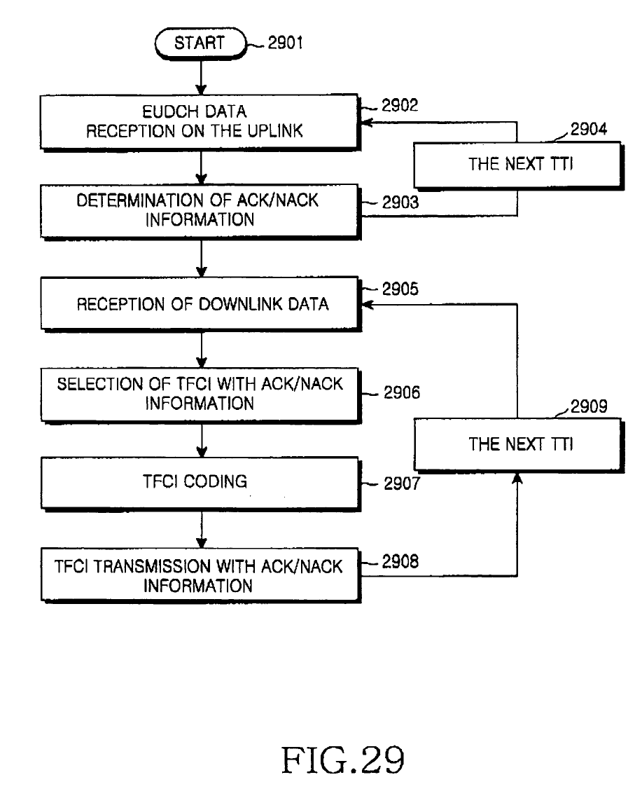

FIG. 29 is a flowchart illustrating an operation for transmitting an ACK/NACK signal by a TFCI in the Node B according to a preferred embodiment of the present invention. Referring to FIG. 29, as the EUDCH service is set up between the UE and the Node B in step 2901, the UE transmits packet data on the uplink. Thus, the Node B receives EUDCH data blocks on the uplink in step 2902. The Node B determines an ACK/NACK by evaluating the EUDCH data blocks in step 2903 and receives EUDCH data blocks for the next TTI in step 2904. When data blocks destined for the UE arrive at the Node B from a higher layer system in step 2905, the Node B selects a TFCI according to an appropriate TF for the data blocks and the ACK/NACK in step 2906. In the absence of the downlink data blocks, the TFCI formed according to the ACK/NACK alone. The TFCI is encoded in step 2907 and transmitted to the UE in step 2908. In step 2909, the Node B repeats TFCI selection and transmission for the next TTI.

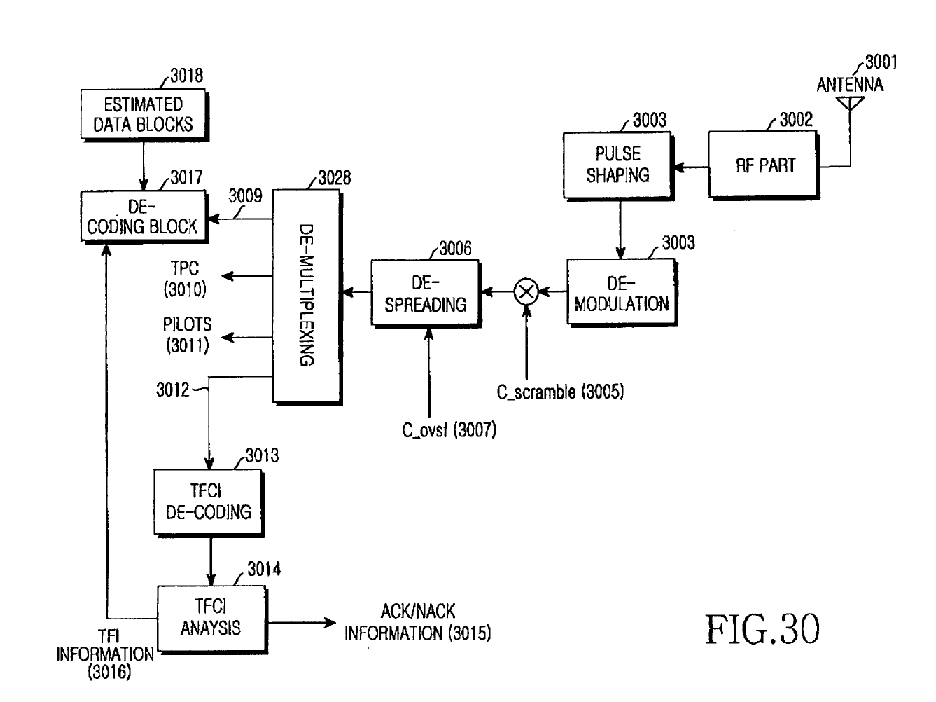

FIG. 30 is a block diagram of a receiver in the UE, for receiving the ACK/NACK signal by the TFCI on the downlink according to a preferred embodiment of the present invention. Referring to FIG. 30, an RF signal received on the downlink through a receive antenna 3001 is converted to a baseband signal through frequency downconversion in an RF part 3002, pulse shaping in a pulse shaping filter 3003, and demodulation in a demodulator 3004. The baseband signal is descrambled with the scrambling code C_scramble in a multiplier 3005 and despread with the OVSF code, C_ovsf, in a despreader 3006.

A DEMUX 3008 demultiplexes the despread signal into a data part 3009, a TPC signal 3010, a pilot signal 3011, and a TFCI 3012. The TFCI 3012 is provided to a TFCI analyzer 3014 through a first decoder 3013. The TFCI analyzer 3014 extracts TFI information 3016 representing the TFs of transport channels and an ACK/NACK 3028 by analyzing the decoded TFCI. The EUDCH scheduling grant information 3028 indicates a maximum data rate set by the Node B. A second decoder 3017 decodes the data part 3009 using the TFI information 3016, thereby obtaining estimated data blocks 3018. The estimated data blocks 3034 are interpreted as packet data in a higher layer.

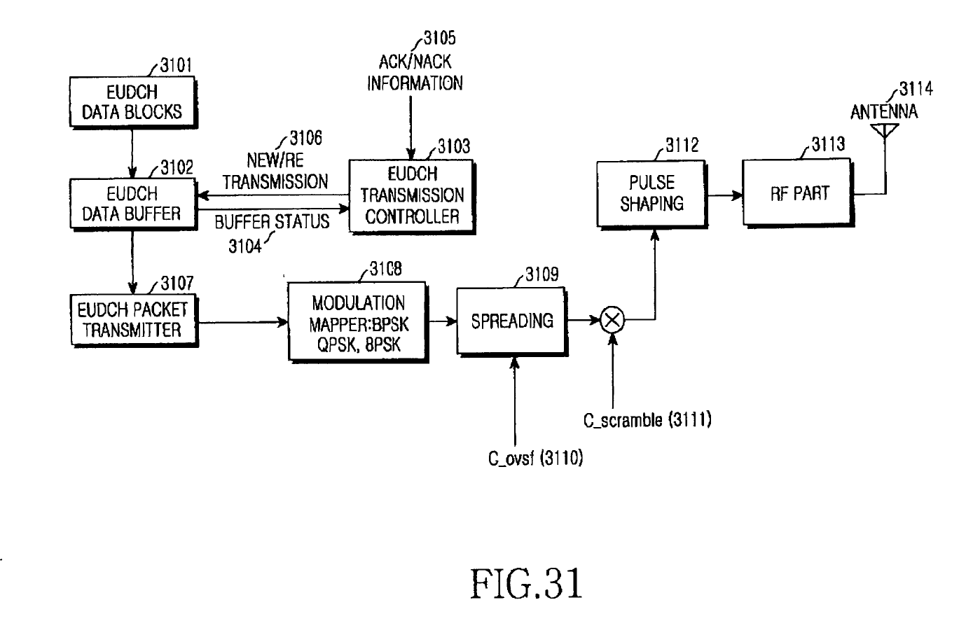

FIG. 31 a block diagram of a transmitter in the UE, for receiving the ACK/NACK signal using the TFCI and transmitting EUDCH data blocks on the uplink according to a preferred embodiment of the present invention. Referring to FIG. 31, the physical layer of the UE, for which the EUDCH service has been established, receives EUDCH data blocks 3101 from a higher layer and buffers them in a data buffer 3102, for transmission on the EUDCH. The buffer 3102 reports its status 3104 to an EUDCH transmission controller 3103. The buffer status 3104 represents the amount of the buffered data. The EUDCH transmission controller 3103 transmits a new data/retransmission data transmission command 3106 to the buffer 3102 according to ACK/NACK information 3105 (3015 in FIG. 30) received from the receiver illustrated in FIG. 30. The buffer 3102 then outputs the previous transmitted data or new data to an EUDCH packet transmitter 3107 in response to the command 3106.

The EUDCH packet transmitter 3107 encodes the data in an available TF and a modulation mapper 3108 modulates the coded data in BPSK, QPSK, or 8PSK. The modulated signal is spread with the OVSF code C_ovsf at a chip rate in a spreader 3109 and scrambled with the scrambling code C_scramble in a multiplier 3120. The scrambled signal is transmitted to a transmit antenna 3114 through a pulse shaping filter 3112 and an RF part 2813.

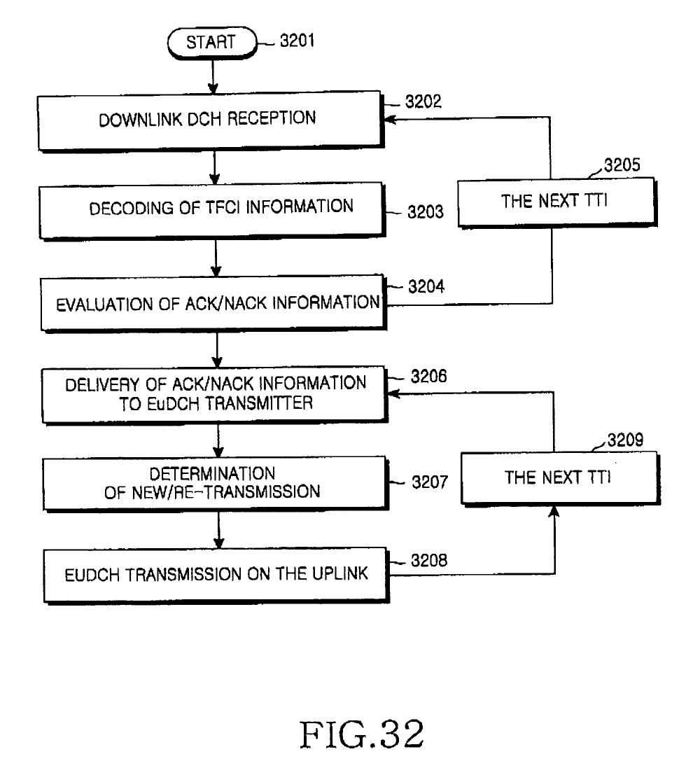

FIG. 32 is a flowchart illustrating an operation for acquiring an ACK/NACK signal and transmitting EUDCH data blocks in the physical layer of the UE according to a preferred embodiment of the present invention. Referring to FIG. 32, as the EUDCH service starts in step 3201, the UE receiver receives a DCH signal on the downlink in step 3202. TFCI information is extracted from the DCH signal in step 3203 and an ACK/NACK is acquired from the TFCI information through decoding in step 3204. When the next TTI comes in step 3205, the UE receiver returns repeats step 3202 through step 3206.

In step 3206, the ACK/NACK is provided to the UE transmitter. The transmitter determines whether to transmit new data or retransmit previously transmitted data according to the ACK/NACK in step 3207. The packet transmission controller provides a transmission command to the packet buffer according to the determination result so that the packet data transmitter transmits data blocks received from the buffer on the uplink in step 3208. Accordingly, the UE transmitter acquires an ACK/NACK from a TFCI and determines whether to transmit new data or to retransmit previously transmitted data according to the ACK/NACK. In step 3209, the UE transmitter proceeds to the next TTI and repeats steps 3206, 3207 and 3208.

As described above, the present invention advantageously reduces signaling overhead arising from transmission of scheduling grant information or an ACK/NACK signal from a Node B to a UE in Node B controlled scheduling or uplink packet data transmission by HARQ, while minimizing modifications, which might be made to physical channel configurations for an EUDCH service in a UMTS system.

While the present invention has been shown and described with reference to certain preferred embodiments thereof, it will be understood by those skilled in the art that various changes in form and details may be made therein without departing from the spirit and scope of the present invention as defined by the appended claims.

1. A method of controlling uplink packet data transmission in a mobile communication system, comprising the steps of:
acquiring transport format combination indicators (TFCIs) representing combinations of transport formats (TFs) of transport channels used for downlink packet data and TFs of a virtual transport channel used for controlling uplink packet data transmission;
determining a downlink signal destined for a user equipment (UE), for controlling the uplink packet data transmission;
selecting a TFCI corresponding to the downlink signal among the acquired TFCIs; and
transmitting the selected TFCI to the UE.

2. The method of claim 1, wherein the TFs of the virtual transport channel are uplink data rate control commands.

3. The method of claim 2, wherein the TFs of the virtual transport channel command at least one of rate-up, no change, rate-down, and transmission suspend in the uplink data rate.

4. The method of claim 2, wherein the TFs of the virtual transport channel represent available uplink data rates.

5. The method of claim 1, further comprising the steps of:
receiving scheduling information including information about a status of a buffer of the UE for storing uplink packet data and channel quality information representing one of an uplink transmit power and an uplink transmit power margin of the UE; and
scheduling the uplink packet data transmission for the UE based on the scheduling information.

6. The method of claim 5, wherein the step of determining the downlink signal comprises the steps of:
determining a maximum uplink data rate according to the scheduling information; and
generating a downlink signal representing the determined uplink data rate.

7. The method of claim 1, wherein the TFs of the virtual transport channel represent at least one of an acknowledgement (ACK) and a negative-acknowledgement (NACK) for the uplink packet data.

8. The method of claim 7, further comprising the step of determining at least one of the ACK and the NACK for the uplink packet data according to if the uplink packet data has been received successfully from the UE.

9. A method of controlling uplink packet data transmission in a mobile communication system, comprising the steps of:
receiving, from a Node B, a transport format combination indicator (TFCI) indicating one of combinations of transport formats (TFs) of transport channels used for downlink packet data and TFs of a virtual transport channel used for controlling the uplink packet data transmission;
acquiring a downlink signal for controlling the uplink packet data transmission according to the received TFCI; and
controlling the uplink packet data transmission according to the downlink signal.

10. The method of claim 9, wherein the TFs of the virtual transport channel are uplink data rate control commands.

11. The method of claim 10, wherein the TFs of the virtual transport channel command at least one of rate-up, no change, rate-down, and transmission suspend in the uplink data rate.

12. The method of claim 10, wherein the TFs of the virtual transport channel represent available uplink data rates.

13. The method of claim 10, further comprising the step of:
transmitting scheduling information to the Node B,
wherein the scheduling information includes information about the status of a buffer of the UE for storing uplink packet data and channel quality information representing one of an uplink transmit power and an uplink transmit power margin of the UE.

14. The method of claim 10, wherein the step of controlling the uplink packet data transmission comprises the steps of:
determining a maximum uplink data rate according to the downlink signal; and
transmitting uplink packet data within the maximum uplink data rate.

15. The method of claim 9, wherein the TFs of the virtual transport channel represent at least one of an acknowledgement (ACK) and a negative-acknowledgement (NACK) for the uplink packet data.

16. The method of claim 15, further comprising the steps of:
if the downlink signal represents the ACK, transmitting new uplink packet data; and
if the downlink signal represents the NACK signal, retransmitting previously transmitted uplink packet data.

17. An apparatus for controlling uplink packet data transmission in a Node B in a mobile communication system, comprising:
a controller for determining a downlink signal for a user equipment (UE), for controlling the uplink packet data transmission;
a transport format combination indicator (TFCI) selector for selecting a TFCI corresponding to the downlink signal among TFCIs representing combinations of transport formats (TFs) of transport channels used for downlink packet data and TFs of a virtual transport channel used for controlling uplink packet data transmission; and
a transmitter for transmitting the selected TFCI to the UE.

18. The apparatus of claim 17, wherein the TFs of the virtual transport channel are uplink data rate control commands.

19. The apparatus of claim 18, wherein the TFs of the virtual transport channel command at least one of rate-up, no change, rate-down, and transmission suspend in the uplink data rate.

20. The apparatus of claim 18, wherein the TFs of the virtual transport channel represent available uplink data rates.

21. The apparatus of claim 17, further comprising a scheduling information receiver for receiving scheduling information from the UE,
wherein the scheduling information includes information about a status of a buffer of the UE for storing uplink packet data and channel quality information representing one of an uplink transmit power and an uplink transmit power margin of the UE.

22. The apparatus of claim 21, wherein the controller determines a maximum uplink data rate according to the scheduling information and generates the downlink signal representing the determined uplink data rate.

23. The apparatus of claim 17, wherein the TFs of the virtual transport channel represent at least one of an acknowledgement (ACK) and a negative-acknowledgement (NACK) for the uplink packet data.

24. The apparatus of claim 23, wherein the controller determines the ACK and the NACK for the uplink packet data according to if the uplink packet data has been received successfully from the UE.

25. An apparatus for controlling uplink packet data transmission in a user equipment (UE) in a mobile communication system, comprising:
a transport format combination indicator (TFCI) receiver for receiving, from a Node B, a TFCI indicating one of combinations of transport formats (TFs) of transport channels used for downlink packet data and TFs of a virtual transport channel used for controlling the uplink packet data transmission;
an analyzer for acquiring a downlink signal for controlling the uplink packet data transmission according to the received TFCI; and
a packet data transmitter for controlling the uplink packet data transmission according to the downlink signal.

26. The apparatus of claim 25, wherein the TFs of the virtual transport channel are uplink data rate control commands.

27. The apparatus of claim 26, wherein the TFs of the virtual transport channel command at least one of rate-up, no change, rate-down, and transmission suspend in the uplink data rate.

28. The apparatus of claim 26, wherein the TFs of the virtual transport channel represent available uplink data rates.

29. The apparatus of claim 26, further comprising a scheduling information transmitter for transmitting scheduling information to the Node B,
wherein the scheduling information includes information about a status of a buffer of the UE for storing uplink packet data and channel quality information representing one of an uplink transmit power and uplink transmit power margin of the UE.

30. The apparatus of claim 26, wherein the packet data transmitter transmits uplink packet data within a maximum uplink data rate determined according to the downlink signal.

31. The apparatus of claim 25, wherein the TFs of the virtual transport channel represent at least one of an acknowledgement (ACK) and a negative-acknowledgement (NACK) for the uplink packet data.

32. The apparatus of claim 31, wherein the packet data transmitter transmits new uplink packet data if the downlink signal represents the ACK and retransmits previously transmitted uplink packet data if the downlink signal represents the NACK.
